(19) United States
(12) Patent Application Publication
(10) Pub. No.: US 2024/0281671 A1
(43) Pub. Date: Aug. 22, 2024

(54) SYSTEM AND METHODS FOR UPDATING DIGITAL TWINS

(71) Applicant: Accenture Global Solutions Limited, Dublin 4 (IE)

(72) Inventors: Kanchanjot Kaur Phokela, New Delhi (IN); Kapil Singi, Bangalore (IN); Kuntal Dey, Birbhum (IN); Vikrant Kaulgud, Pune (IN); Teresa Sheausan Tung, Los Angeles, CA (US)

(21) Appl. No.: 18/112,481

(22) Filed: Feb. 21, 2023

(51) Int. Cl. G06N 5/022

(52) U.S. Cl. CPC G06N 5/022

(57) ABSTRACT

Aspects of the present disclosure provide systems, methods, and computer-readable storage media that support ontology driven processes to generate and/or update digital twins using a partially automated process. To generate the digital twin, an ontology may be obtained and used to generate a hierarchy model, from which a knowledge graph is generated and represents a digital twin. Similarity measurements may be performed on the knowledge graph, such as components thereof, to determine a similarity between the components. Components are ranked and clustered to identify clusters of similar components and new relationships between components. This new information may be used to update the knowledge model and/or knowledge graph. Updating the knowledge graph or model may enable generation of an updated digital twin and enable continued updating of additional different data structures for other similar elements.

### TECHNICAL FIELD

The present disclosure relates generally to system modelling and more specifically to techniques for ontology driven self-adaptive digital twins.

### BACKGROUND

Presently, entities across many different industries are seeking to incorporate the use of digital twins to test, streamline, or otherwise evaluate various aspects of their operations. One such industry is the automotive industry, where digital twins has been explored as a means to analyze and evaluate performance of a vehicle. To illustrate, the use of digital twins has been explored as a means to safely evaluate performance of autonomous vehicles in mixed driver environments (i.e., environments where autonomous vehicles are operating in the vicinity of human drivers). As can be appreciated from the non-limiting example(s) above, the ability to analyze performance or other factors of a system or process using a digital twin, rather than its real world counterpart (e.g., the vehicle represented by the digital twin), can provide significant advantages. Although the use of digital twins has proven useful across many different industries, much of the current interest is focused on the benefits that may be realized by using digital twins, and other challenges have gone unaddressed.

One particular challenge that remains with respect to the use of digital twins is maintaining and updating the digital twins after creation of the digital twins themselves to keep up with evolving systems or process. Specifically, as the systems upon which they are based or modeled may evolve and change, the digital twins must be updated to ensure the changes are reflected in the digital twins and knowledge models. However, there are no update mechanisms for digital twins. For example, tools currently exist to aid in the creation of digital twins, but most existing tools are limited in the sense that they are manual processes, data intensive, and expertise driven. Additionally, an entity may offer a digital twin platform specific to systems, products, or services of the entity, but such digital twin platforms may not be capable of being utilized for other systems, products, or services (i.e., the digital twin platform is only compatible with the entity's system(s), products, services, etc.). Furthermore, such entity-specific digital twins are not capable of being modified or customized by users, thereby limiting the information that may be obtained from the digital twin to those use cases approved or created by the entity, rather than the ultimate end users of the digital twin platform.

As a result, users of digital twins may seek to utilize multiple tools to develop digital twins covering different portions of a use case of interest. In such instances additional challenges may occur, such as digital twins created using different tools being incompatible with each other, thereby limiting the types of analysis and insights that may be obtained using the digital twins. Additionally, some digital twin creation tools are not well-suited with respect to addressing changes to the real world counterpart and may require re-designing and rebuilding the digital twin each time changes to the real world counterpart occur. This can be particularly problematic for uses cases involving industries where changes frequently occur, such as the manufacturing industry. An additional challenge that occurs when creating digital twins is that existing platforms or tools for creating digital twins do not support customization of the types of information that can be used with the digital twin, thereby limiting the ability to create a digital twin that utilizes information that allows meaningful evaluation of a use case of interest. For example, it can be difficult to use statically designed digital twin creation tools (i.e., digital twin tools designed for a specific use case or real world counterpart) with certain types of information, such as time series information or a new use case. This is because static digital twin design tools and platforms are designed to create digital twins for a specific use case or real world counterpart with data defined a priori and such tools do not enable customization of the digital twin to reflect changes to the use case or real world counterpart for which the tools or platforms were designed. Another challenge is scaling of digital twins. For example, a digital twin may describe a set of data that may be used for evaluation purposes, but the dataset may be limited in size or limited in the data structure complexity and may not support the ability to incorporate new more complex types of information, such as time-series data or hierarchical data.

Some digital twins may leverage certain types of ontological reasoning in an attempt to provide decision support systems, such as knowledge graphs. An ontology may allow domain-specific data to be represented in knowledge graphs, but knowledge graphs typically represent data in an absolute way and do not support reasoning under certain conditions. Additionally, although knowledge graphs provide semantic expressiveness in modelling domain-specific data, the insights provided by a knowledge graph are insufficient to provide probabilistic reasoning capabilities. Thus, relationships may be derived from data of past events, but uncertain future events are not capable of being probabilistically modelled, limiting the usefulness of a corresponding digital twin in predicting future data related to its real world counterpart. Thus, while digital twins have shown promise as a tool for evaluating real world designs, the above-described drawbacks have limited the benefits that may be realized by using digital twins.

### SUMMARY

Aspects of the present disclosure provide systems, methods, and computer-readable storage media that support ontology-driven modeling processes and tools to adaptively generate and/or update knowledge graph models that extend the capabilities of digital twins with respect to inferencing, prediction, decision making, and querying to larger and more complex systems and enable maintenance and management of digital twins, such as siloed digital twins. The process of adaptively updating a knowledge graph (e.g., a digital twin) leverages an ontology representing a real world system, machine, process, workflow, organization, application, and the like, and domain data to construct a knowledge hierarchy (e.g., a knowledge hierarchy model) From the knowledge hierarchy, a knowledge graph or graphs can be generated. Using the knowledge hierarchy, an ontology feedback engine can perform similarity determination on nodes of the knowledge graph(s) for rank calculation and clustering. The clustered component information can be used to automatically generate recommendations for an ontology adaptive feedback process that can be used to generate and/or update a knowledge graph (e.g., a digital twin). For example, two disparate digital twins may be combined into a larger heterogenous digital twin. By utilizing knowledge hierarchy and an adaptive feedback mechanisms heterogenous digital twins with ontologies (including domain knowledge and modeling data) can be generated and maintained automatically. This will ensure seamless scaling of the application structure, targeted insights, and abstracted preview of the end-to-end system. To keep up with the ever-changing data intensive twins, ontologies will provide as core base for standardization, correlation and abstraction which will facilitate easy binding with the dynamic nature of these heterogenous twins.

In a particular aspect, a method for updating digital twins includes: obtaining, by one or more processors, knowledge hierarchy information including digital twin structure information, ontology information, and relationship information; determining, by the one or more processors, a knowledge graph based on the knowledge hierarchy information, wherein the knowledge graph represents a digital twin of a real world counterpart; performing, by the one or more processors, similarity measurements on the knowledge graph to generate similarity information for one or more variables of the knowledge graph; performing, by the one or more processors, variable ranking calculations on the similarity information to generate ranked similarity information for one or more variables of the knowledge graph; performing, by the one or more processors, variable clustering operations on the ranked similarity information to generate variable cluster information for one or more variables of the knowledge graph; and outputting, by the one or more processors, a recommendation for updating the knowledge hierarchy information, the knowledge graph, or both, based on the variable cluster information.

In another particular aspect, a system for creating digital twins includes a memory and one or more processors communicatively coupled to the memory. The one or more processors are configured to obtain a dataset. The dataset includes an ontology and domain data corresponding to a domain associated with the ontology. The one or more processors are also configured to: obtain knowledge hierarchy information including digital twin structure information, ontology information, and relationship information; determine a knowledge graph based on the knowledge hierarchy information, wherein the knowledge graph represents a digital twin of a real world counterpart; perform similarity measurements on the knowledge graph to generate similarity information for one or more variables of the knowledge graph; perform variable ranking calculations on the similarity information to generate ranked similarity information for one or more variables of the knowledge graph; perform variable clustering operations on the ranked similarity information to generate variable cluster information for the one or more variables of the knowledge graph; and output a recommendation for updating the knowledge hierarchy information, the knowledge graph, or both, based on the variable cluster information.

In another particular aspect, a non-transitory computer-readable storage medium stores instructions that, when executed by one or more processors, cause the one or more processors to perform operations for creating digital twins. The operations include: obtaining knowledge hierarchy information including digital twin structure information, ontology information, and relationship information; determining a knowledge graph based on the knowledge hierarchy information, wherein the knowledge graph represents a digital twin of a real world counterpart; performing similarity measurements on the knowledge graph to generate similarity information for one or more variables of the knowledge graph; performing variable ranking calculations on the similarity information to generate ranked similarity information for the one or more variables of the knowledge graph; performing variable clustering operations on the ranked similarity information to generate variable cluster information for the one or more variables of the knowledge graph; and outputting a recommendation for updating the knowledge hierarchy information, the knowledge graph, or both, based on the variable cluster information.

The foregoing has outlined rather broadly the features and technical advantages of the present disclosure in order that the detailed description that follows may be better understood. Additional features and advantages will be described hereinafter which form the subject of the claims of the disclosure. It should be appreciated by those skilled in the art that the conception and specific aspects disclosed may be readily utilized as a basis for modifying or designing other structures for carrying out the same purposes of the present disclosure. It should also be realized by those skilled in the art that such equivalent constructions do not depart from the scope of the disclosure as set forth in the appended claims. The novel features which are disclosed herein, both as to organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an example of a system that supports creation of self-adaptive digital twins and updating digital twins according to one or more aspects of the present disclosure;

FIG. 2A shows a block diagram illustrating exemplary aspects of a knowledge graph in accordance with aspects of the present disclosure;

FIG. 2B is a block diagram of an example of a knowledge graph according to one or more aspects of the present disclosure;

FIG. 3 is a block diagram of another example of a knowledge graph according to one or more aspects of the present disclosure;

FIG. 4 is a block diagram of another example of a knowledge graph according to one or more aspects of the present disclosure;

FIG. 5 is a block diagram of an example of an adaptive ontology feedback process according to one or more aspects of the present disclosure;

FIG. 6 is a block diagram of an example of a knowledge hierarchy model according to one or more aspects of the present disclosure;

FIG. 7 is a diagram of an example of a similarity graph according to one or more aspects of the present disclosure;

FIG. 8 is a diagram of an example of a component ranking mechanism according to one or more aspects of the present disclosure;

FIG. 9 is a diagram of an example of a cluster component graph according to one or more aspects of the present disclosure;

FIG. 10 is a block diagram of an example of a component graph and of a clustered ranked component graph according to one or more aspects of the present disclosure;

FIG. 11 is a block diagram of an example of an updated knowledge hierarchy model according to one or more aspects of the present disclosure;

FIG. 12 is a block diagram of an example of an updated knowledge graph according to one or more aspects of the present disclosure; and

FIG. 13 is a flow diagram illustrating an example of a method for updating a digital twin according to one or more aspects of the present disclosure.

It should be understood that the drawings are not necessarily to scale and that the disclosed aspects are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular aspects illustrated herein.

### DETAILED DESCRIPTION

Aspects of the present disclosure provide systems, methods, and computer-readable storage media that support ontology-driven modeling processes and tools to adaptively generate and/or update knowledge graph models that extend the capabilities of digital twins with respect to inferencing, prediction, decision making, and querying to larger and more complex systems and enable maintenance and management of digital twins, such as siloed digital twins. The process of adaptively updating a knowledge graph (e.g., a digital twin) leverages an ontology representing a real world system, machine, process, workflow, organization, application, and the like, and domain data to construct a knowledge hierarchy (e.g., a knowledge hierarchy model). From the knowledge hierarchy, a knowledge graph or graphs can be generated. Using the knowledge hierarchy, an ontology feedback engine can perform similarity determination on nodes of the knowledge graph(s) for rank calculation and clustering. The clustered component information can be used to automatically generate recommendations for an ontology adaptive feedback process that can be used to generate and/or update a knowledge graph (e.g., a digital twin). For example, two disparate digital twins may be combined into a larger heterogenous digital twin. By utilizing knowledge hierarchy and an adaptive feedback mechanisms heterogenous digital twins with ontologies (including domain knowledge and modeling data) can be generated and maintained automatically. This will ensure seamless scaling of the application structure, targeted insights, and abstracted preview of the end-to-end system. To keep up with the ever-changing data intensive twins, ontologies will provide as core base for standardization, correlation and abstraction which will facilitate easy binding with the dynamic nature of these heterogenous twins.

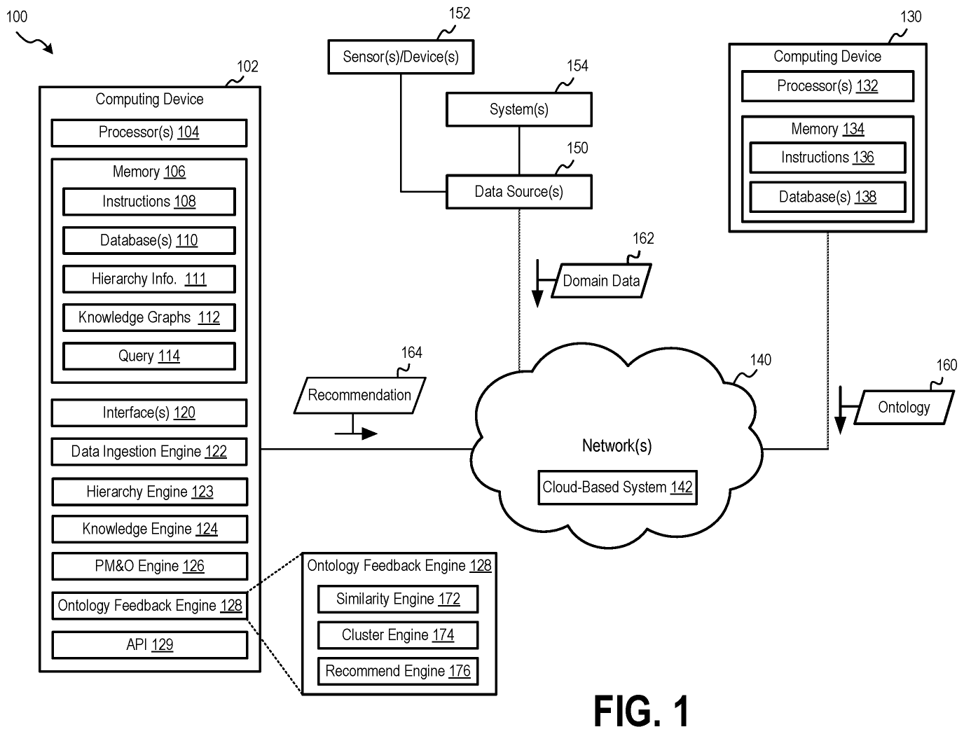

Referring to FIG. 1, an example of a system that supports generation of digital twins according to one or more aspects of the present disclosure is shown as a system 100. The system 100 may be configured to generate or update a digital twin of a real-world counterpart. For example, the system 100 may be configured to generate or recommend automatic updates for heterogenous digital twins, such as identify siloed digital twins and combine the siloed digital twins to generate a new twin. The system 100 may be configured to update knowledge hierarchies, which are used to generate the digital twins (e.g., the knowledge graphs representing the digital twins).

As shown in FIG. 1, the system 100 includes a computing device 102, another computing device 130, one or more data sources (referred to herein as “data sources 150”), one or more sensors and/or devices (referred to herein as “sensors/devices 152”), one or more systems (referred to herein as “systems 154”), and one or more networks 140. In some implementations, the system 100 may include more or fewer components than are shown in FIG. 1, such as additional computing devices, data sources, systems, or the like, or the computing device 130 may be omitted, as non-limiting examples.

The computing device 102 may include or correspond to a desktop computing device, a laptop computing device, a personal computing device, a tablet computing device, a mobile device (e.g., a smart phone, a tablet, a personal digital assistant (PDA), a wearable device, and the like), a server, a virtual reality (VR) device, an augmented reality (AR) device, an extended reality (XR) device, a vehicle (or a component thereof), an entertainment system, other computing devices, or a combination thereof, as non-limiting examples. The computing device 102 includes one or more processors 104, a memory 106, a data ingestion engine 122, a hierarchy engine 123, a knowledge engine 124, a probabilistic modelling and optimization engine 126 (PM&O engine, e.g., a probabilistic modelling engine and an optimization engine), an ontology feedback engine 128, and one or more communication interfaces 120. In some implementations the computing device 102 may also provide one or more an application programming interface (API) 129 that enables interaction with the functionality described in connection with the computing device 102, as described in more detail below. In additional or alternative implementations the API 129 may be provided by another device of the system 100, such as computing device 130, as described in more detail below. In some other implementations, one or more of the components 122-128 may be optional, one or more of the components 122-128 may be integrated into a single component (e.g., the data ingestion engine 122, the hierarchy engine 123, and/or the knowledge engine 124 may be combined, etc.), one or more additional components may be included in the computing device 102, or combinations thereof (e.g., some components may be combined into a single component, some components may be omitted, while other components may be added).

It is noted that functionalities described with reference to the computing device 102 are provided for purposes of illustration, rather than by way of limitation and that the exemplary functionalities described herein may be provided via other types of computing resource deployments. For example, in some implementations, computing resources and functionality described in connection with the computing device 102 may be provided in a distributed system using multiple servers or other computing devices, or in a cloud-based system using computing resources and functionality provided by a cloud-based environment that is accessible over a network, such as the one of the one or more networks 140. To illustrate, one or more operations described herein with reference to the computing device 102 may be performed by one or more servers or a cloud-based system 142 that communicates with one or more client or user devices.

The one or more processors 104 may include one or more microcontrollers, application specific integrated circuits (ASICs), field programmable gate arrays (FPGAs), central processing units (CPUs) and/or graphics processing units (GPUs) having one or more processing cores, or other circuitry and logic configured to facilitate the operations of the computing device 102 in accordance with aspects of the present disclosure. The memory 106 may include random access memory (RAM) devices, read only memory (ROM) devices, erasable programmable ROM (EPROM), electrically erasable programmable ROM (EEPROM), one or more hard disk drives (HDDs), one or more solid state drives (SSDs), flash memory devices, network accessible storage (NAS) devices, or other memory devices configured to store data in a persistent or non-persistent state. Software configured to facilitate operations and functionality of the computing device 102 may be stored in the memory 106 as instructions 108 that, when executed by the one or more processors 104, cause the one or more processors 104 to perform the operations described herein with respect to the computing device 102, as described in more detail below. Additionally, the memory 106 may be configured to store data and information in one or more databases 110, as well as knowledge graphs 112 and a query 114. Illustrative aspects of the one or more databases 110, the knowledge graphs 112, and the query 114 are described in more detail below.

The one or more communication interfaces 120 may be configured to communicatively couple the computing device 102 to the one or more networks 140 via wired or wireless communication links established according to one or more communication protocols or standards (e.g., an Ethernet protocol, a transmission control protocol/internet protocol (TCP/IP), an Institute of Electrical and Electronics Engineers (IEEE) 802.11 protocol, an IEEE 802.16 protocol, a 3rd Generation (3G) communication standard, a 4th Generation (4G)/long term evolution (LTE) communication standard, a 5th Generation (5G) communication standard, and the like). In some implementations, the computing device 102 includes one or more input/output (I/O) devices (not shown in FIG. 1) that include one or more display devices, a keyboard, a stylus, one or more touchscreens, a mouse, a trackpad, a microphone, a camera, one or more speakers, haptic feedback devices, or other types of devices that enable a user to receive information from or provide information to the computing device 102. In some implementations, the computing device 102 is coupled to the display device, such as a monitor, a display (e.g., a liquid crystal display (LCD) or the like), a touch screen, a projector, a virtual reality (VR) display, an augmented reality (AR) display, an extended reality (XR) display, or the like. In some other implementations, the display device is included in or integrated in the computing device 102.

The data ingestion engine 122 may be configured to provide functionality for collecting data to support the functionality provided by the computing device 102. For example, the data ingestion engine 122 may provide functionality for obtaining data to support the operations of the computing device 102 from one or more data sources. Exemplary types of data that may be obtained using the data ingestion engine 122 include one or more ontologies, domain data associated with one or more domains of the ontologies, data collected by Internet of Things (IoT) devices, infrastructure data, financial data, mapping data, time series data, SQL data, registration data, user data, patient data, medical records, or other types of data. The data obtained by the data ingestion engine 122 may be stored in the one or more databases 110 and used by the probabilistic modelling and optimizations engine 126 to generate probabilistic models that enable observations, simulations, and other types of operations to be performed, as described in more detail below. Additionally or alternatively, the data obtained by the data ingestion engine 122 and/or the data stored in the one or more databases 110 may be used by the probabilistic modelling and optimizations engine 126 (e.g., the optimization engine) to make decisions to optimize or otherwise satisfy criteria for one or more variables associated with the probability distributions.

The ontologies obtained by the data ingestion engine 122 provide an abstracted representation of an entity that represents or defines concepts, properties, and relationships for the entity using an accepted body of knowledge (e.g., industry accepted terminology and semantics). The ontologies may specify object types and their semantic relationship to other object types via graph format. Exemplary formats in which the ontologies may be obtained by the data ingestion engine 122 include “.owl” and “.ttl,” files. As a non-limiting example, an ontology for a manufacturer may indicate the manufacturer has production facilities in one or more geographic locations and include, for each production facility, information representing: a floor plan for the production facility, manufacturing infrastructure present at the production facility (e.g., assembly robots, computing infrastructure, equipment, tools, and the like), locations of the manufacturing infrastructure within the production facility, other types of information, or combinations thereof. It is noted that while the exemplary characteristics of the above-described ontology have been described with reference to a manufacturer domain, the ontologies obtained by the data ingestion engine 122 may include ontologies representative of other types of domains, such as ontologies associated with processes (e.g., manufacturing processes, computing processes, biological processes, chemical processes, medical treatment processes, customer transaction management processes, etc.), ontologies associated with machinery or equipment (e.g., a vehicle, a computing device or component thereof, circuitry, robots, etc.), ontologies associated with biological systems, and the like. Accordingly, it should be understood that the operations disclosed herein with reference to the computing device 102 may be applied to any industry, process, machine, etc. capable of representation via an ontology.

The hierarchy engine 123 (e.g., knowledge model instantiation engine) provides functionality for generating a knowledge hierarchy based on an ontology provided to the computing device 102 and data. For example, the computing device 130 may provide an ontology 160 to the computing device 102 and the ontology 160 may include information descriptive of a real world system, process, device, and the like, such as the systems 154, as a non-limiting example. The data may also include domain data 162 that corresponds to information obtained from the real world system, process, device, etc., such as operational data, configuration data, output data, performance data, and the like. For example, the domain data 162 may be received from the data sources 150, the sensors 152, and/or the systems 154. As described in more detail below, the hierarchy engine 123 may generate hierarchy information (e.g., a knowledge hierarchy model) based on the ontology 160 and the domain data 162. For example, the hierarchy engine 123 may provide functionality for creating a knowledge hierarchy model corresponding to the real world counterpart (e.g., the systems 154, in some examples) associated with the ontology 160 and with interconnections (e.g., relationships) which can be used to generate digital twin(s) and/or adaptively update digital twin(s), as described in more detail below.

The knowledge engine 124, the probabilistic modelling and optimization engine 126, and the ontology feedback engine 128 provide functionality for generating a digital twin based on an ontology provided to the computing device 102 and data. For example, the computing device 130 may provide an ontology 160 to the computing device 102 and the ontology 160 may include information descriptive of a real world system, process, device, and the like, such as the systems 154, as a non-limiting example. The data may also include domain data 162 that corresponds to information obtained from the real world system, process, device, etc., such as operational data, configuration data, output data, performance data, and the like. For example, the domain data 162 may be received from the data sources 150, the sensors 152, and/or the systems 154. As described in more detail below, the knowledge engine 124, the probabilistic modelling and optimizations engine 126 (e.g., the optimization engine thereof) may generate a digital twin based on the ontology 160 and the domain data 162. For example, the hierarchy engine 123, the knowledge engine 124, the probabilistic modelling and optimizations engine 126, and the ontology feedback engine 128 may provide functionality for creating a digital twin corresponding to the real world counterpart (e.g., the systems 154, in some examples) associated with the ontology 160.

As described in more detail below, the digital twin may be created by instantiating the ontology 160 as a knowledge graph of the knowledge graphs 112. For example, the knowledge engine 124 provides the functionality for generating the domain ontology knowledge graph (e.g., or a portion or layer thereof), the probabilistic modelling and optimizations engine 126 provides the functionality for generating the probabilistic ontology graph model (e.g., the second layer), and the probabilistic modelling and optimizations engine 126 (e.g., the optimization engine thereof) provides the functionality for generating the decision optimization layer, as further described herein.

The knowledge engine 124 may further include a knowledge model query engine. The knowledge model query engine provides the functionality for querying or retrieving the knowledge hierarchy model (e.g., the hierarchy information 111, also referred to as knowledge hierarchy or knowledge hierarchy information) and determining and labeling the relationships of the knowledge graph or graphs using the knowledge hierarchy model.

In some implementations, the knowledge graph is a multi-layer probabilistic knowledge graph that includes multiple layers, such as a first layer, a second layer that is layered on the first layer, and a third layer that is layered on the second layer, with the first layer including or corresponding to a domain ontology knowledge graph, the second layer including or corresponding to a probabilistic ontology graph model, and the third layer including or corresponding to a decision optimization model.

A knowledge graph may represent a network where nodes represent concepts and directed edges represent relationships between concepts. Relationship types indicated by at least some knowledge graphs can be broadly classified into two categories: those that specify the underlying hierarchical structure of the data, and those that specify other types of relationships between concepts. A fact in a knowledge graph may be composed of a triple containing a source concept, relationship, and target concept. As a non-limiting example, a fact may be represented by the triple Panda-eats-Bamboo. Knowledge graphs may typically be structured via an expert-curated domain ontology that defines how various types of data relate to each other. The ontology specifies how each relationship type can be used. As an example, an ontology about movies may contain a relationship called “appeared in,” and the ontology may specify that this relationship must connect a node that is a subclass of actor or actress to a node that is a subclass of movie. In their general form, knowledge graphs do not support reasoning under uncertainty, as each link indicates an absolute truth.

Additionally, or alternatively, a knowledge graph may represent uncertainty and/or represent real-world decisions that are made based on an optimization of the uncertainty. In this manner, the functionality provided by the hierarchy engine 123, the knowledge engine 124, the probabilistic modelling and optimizations engine 126, and the ontology feedback engine 128 for creating digital twins enables complex digital twins to be created that provide semantic information, probability distributions, and decision making capabilities for the real-world counterpart.

The knowledge graphs 112 include individual heterogenous knowledge graphs for different discrete systems, such as cyber-physical systems. For example, the knowledge graphs 112 may include a first knowledge graph for an application and a second knowledge graph for a network (e.g., a cloud based network). The system 100 enables generation of a third knowledge graph (and/or updates to the first and or second knowledge graphs) based on the first knowledge graph and the second knowledge graph to enable modeling of a heterogenous digital twin system, such as placing the application on the cloud network. To illustrate, the system 100 can enable automated generation of knowledge graphs 112 which enable modeling of the interactions between the two original separate and distinct digital twins (e.g., siloed digital twins). This modeling of the interactions can be used to deliver real world improvements in software development with minimal resources. Previously, a new larger and complex digital twin would have to be generated from scratch without being able to leverage the previous work done in developing or maintaining the digital twin. Additionally, when a database of digital twins was generated, each knowledge graph for the digital twin had to be updated manually, and the work updating a particular knowledge graph could not be leveraged to update other knowledge graphs.

In some examples, the knowledge graph may include or correspond to a multi-layer probabilistic knowledge graph. A multi-layer probabilistic knowledge graph includes multiple layers that each include a model or other graph-based representation derived from a user-provided ontology, sampled domain data, and, for some layers, the layer(s) below in the multi-layer probabilistic knowledge graph. A multi-layer probabilistic knowledge graph may represent multiple types of information (e.g., semantic knowledge, probabilistic data, decision data, etc.). Exemplary aspects of a multi-layer probabilistic knowledge graph are described in commonly owned U.S. patent application Ser. No. 18/101,579, filed Jan. 25, 2023, and entitled “SYSTEM FOR PROBABILISTIC MODELING AND MULTI-LAYER MODELLING FOR DIGITAL TWINS,” the contents of which are incorporated herein by reference.

The system 100 also enables updating of multiple knowledge graphs of the knowledge graphs 112 based on an update to a single knowledge graph or knowledge hierarchy (e.g., hierarchy information 111), based on an update to the ontology 160 or the domain data 162. For example, the ontology feedback engine 128 provides functionality for updating digital twins based on an update to a knowledge graph or knowledge hierarchy.

As described in more detail below, the ontology feedback engine 128 generates recommendations to update a knowledge graph or knowledge hierarchy. For example, the ontology feedback engine 128 includes one or more component engines (172-176) which provide functionality to enable the ontology feedback engine 128 to provide a feedback loop for updating knowledge graphs and/or knowledge hierarchies. As described in more detail below, the similarity engine 172 may provide functionality to enable data point generation and similarity determination from nodes of knowledge graphs, the cluster engine 174 may include a component rank calculation engine and a component clustering engine which provide functionality to enable component rank calculation and clustering, and the recommendation engine 176 may include a recommendation generation engine and a recommendation output engine which provide functionality to enable recommendation generation and output, such as a recommendation 164.

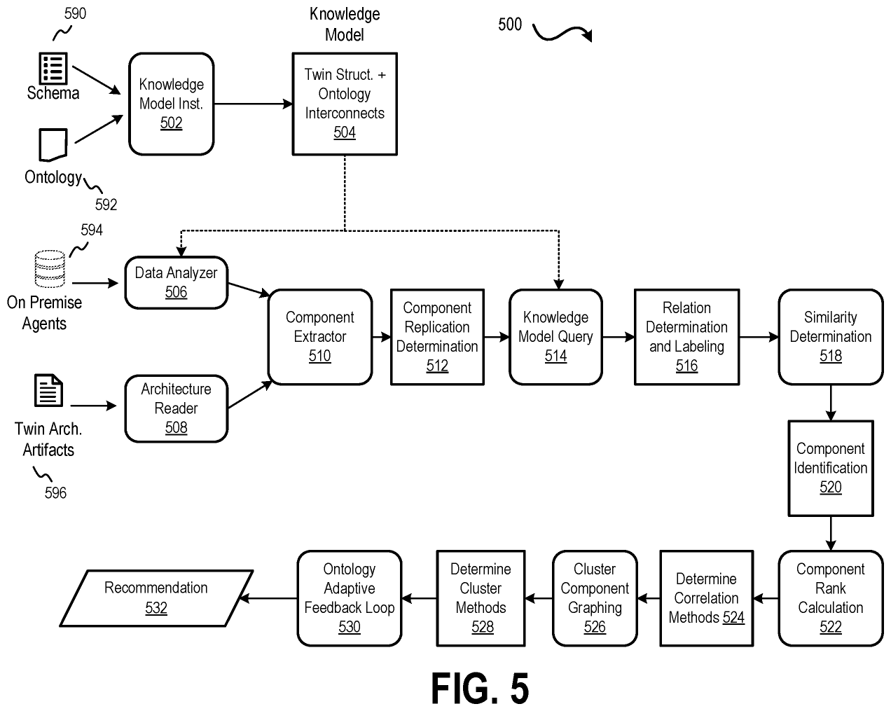

Although the illustration in FIG. 1, depicts the recommendation 164 being sent to another device of FIG. 1, in other implementations, the recommendation 164 may be sent internally within computing device 102. Additionally, the recommendation 164 may be sent to multiple devices, and optionally internally, in other implementations. The recommendation 164 may indicate an update to a knowledge graph, knowledge hierarchy, or both, is further described with reference to FIGS. 5, 11, and 12. The update to a knowledge graph may include merging two knowledge graphs to create a new, larger knowledge graph which depicts an entire system or multiple disparate systems, such as a heterogenous digital twin. As an illustrative example, application or service digital twins may be combined with network or cloud digital twins to model placing or hosting the application or service on the network or cloud. The new knowledge graph may enable modeling of the how the combined system works. The combined system may be queried or analyzed to enable improved software development tools (such as automated software testing/simulation or insight generation (e.g., key performance indicator (KPI) development or refinement).

In an aspect, the computing device 102 may provide an API 129 (which may be one or more APIs in some implementations). The API 129 may enable communication with an application executed by a user (e.g., a user of the computing device 130) and provide functionality for creating digital twins in accordance with the concepts described herein. For example, the API 129 may provide a command prompt or other means that enable the user to upload an ontology (e.g., the ontology 160), domain data (e.g., the domain data 162), or both, as part of a digital twin creation process. The API 129 may additionally provide functionality for leveraging the capabilities and functionality of the data ingestion engine 122, the hierarchy engine 123, the knowledge engine 124, the probabilistic modelling and optimizations engine 126, and the ontology feedback engine 128 during the digital twin creation process to generate the digital twin in accordance with the concepts described herein. In an aspect, the API 129 may be provided as part of an application, such as an application stored in the memory 106 and executed by the one or more processors 104 (or similar resources of the computing device 130). In an additional or alternative aspect, the API 129 may be provided by a cloud-based system, such as cloud-based system 142, which may be configured to provide the functionality described herein with reference to the computing device 102 from a cloud-based deployment of computing resources. Additionally, or alternatively, the computing device 102 (or the cloud-based system 142) may be configured to provide one or more graphical user interfaces (GUIs) that include visual elements that enable any or all of the functionality described with reference to the API 129.

As briefly described above, the computing device 102 may be communicatively coupled to one or more computing devices 130 via the one or more networks 140. The computing device 130 may include one or more processors 132, a memory 134, one or more I/O devices (not shown in FIG. 1), and one or more communication interfaces (not shown in FIG. 1). The one or more processors 132 may include one or more microcontrollers, ASICs, FPGAs, CPUs and/or GPUs having one or more processing cores, or other circuitry and logic configured to facilitate the operations of the computing device 130 in accordance with aspects of the present disclosure. The memory 134 may include RAM devices, ROM devices, EPROM, EEPROM, one or more HDDs, one or more SSDs, flash memory devices, NAS devices, or other memory devices configured to store data in a persistent or non-persistent state. Software configured to facilitate operations and functionality of the computing device 130 may be stored in the memory 134 as instructions 136 that, when executed by the one or more processors 132, cause the one or more processors 132 to perform the operations described herein with respect to the computing device 130, as described in more detail below. Additionally, the memory 134 may be configured to store data and information in one or more databases 138. Illustrative aspects of the types of information that may be stored in the one or more databases 138 are described in more detail below.

During operation of the system 100, the computing device 102 may receive an ontology 160 from the computing device 130 and domain data 162 from the data sources 150, or alternatively from the computing device 130. The ontology 160 may provide an abstracted semantic representation of a real world counterpart to the digital twin being designed, where the real world counterpart may be an entity, machine, process, system, or other real world design. The ontology 160 may define the real world counterpart using a representation that defines concepts, properties, and relationships for the real world counterpart using an accepted body of knowledge (e.g., industry accepted terminology and semantics) and may specify object types and their semantic relation to other object types via graph format. Exemplary formats in which the ontology 160 may be received by the computing device 102 include “.owl” and “.ttl,” files.

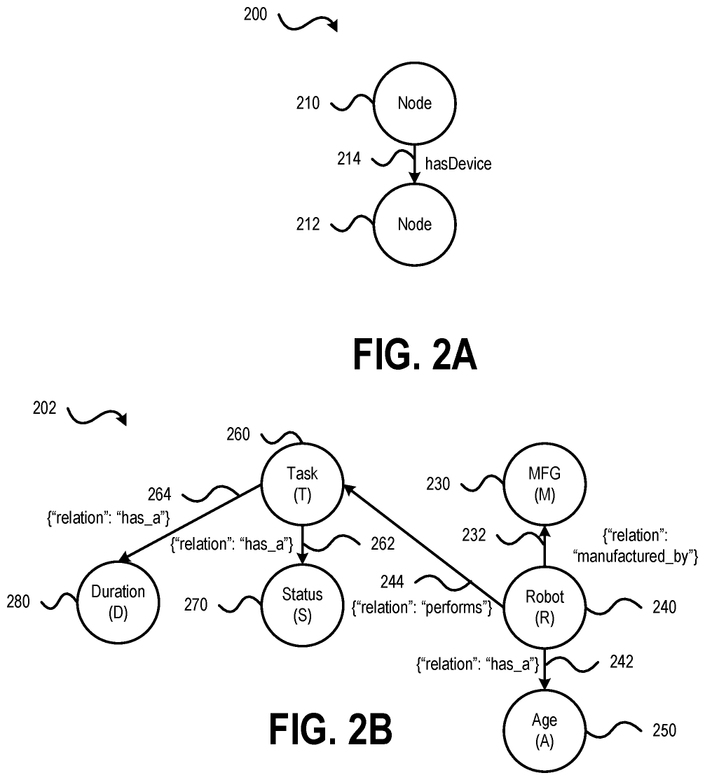

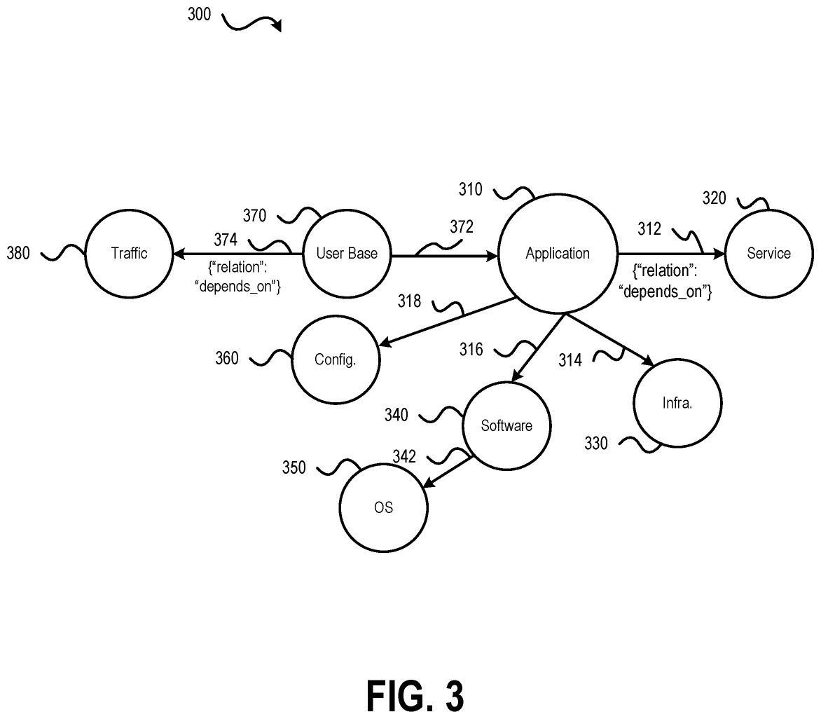

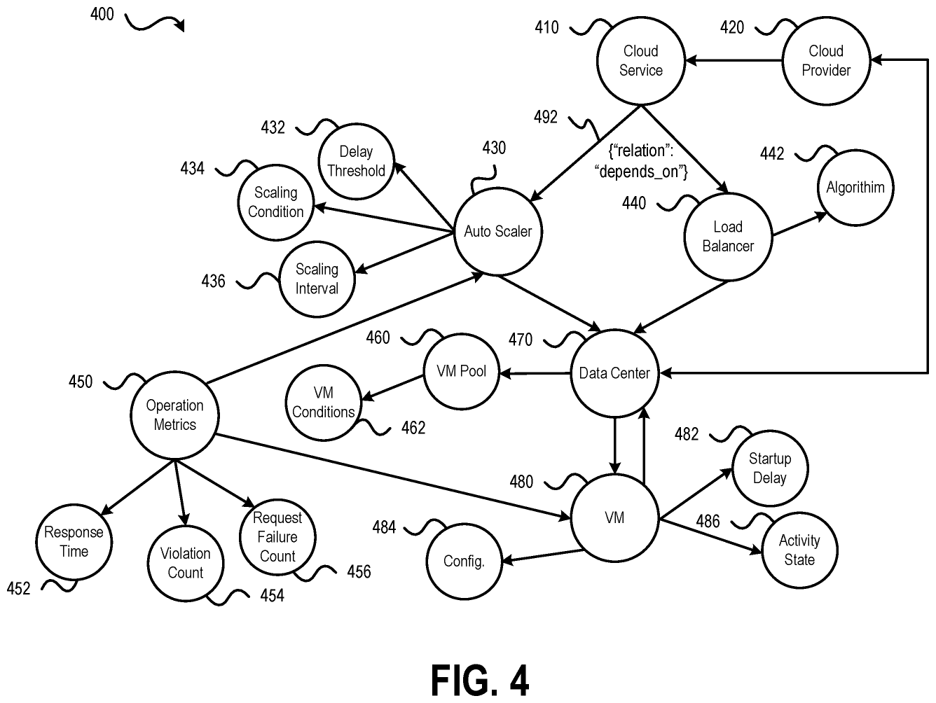

As a non-limiting example, the ontology 160 received by the computing device 102 may include the ontology for a manufacturer as described above and with reference to FIGS. 2A and 2B. Alternatively, the ontology 160 received by the computing device 102 may include an ontology for software applications as described with reference to FIGS. 3 and 4. However, the operations disclosed herein with reference to the computing device 102 may be applied to any industry, process, machine, etc. capable of representation via an ontology. The domain data 162 received by the computing device 102 includes data related to the domain represented by the ontology 160, such as operational data, patient data, sensor data, customer data, transaction data, or other types of data associated with the domain.

As briefly described above, the computing device 102 provides the functionality for generating digital twins. To illustrate, the data ingestion engine 122 receives and ingests the ontology 160 and the domain data 162, and after ingestion, the ontology 160 and the domain data 162 may be provided to the hierarchy engine 123, the knowledge engine 124, and the probabilistic modelling and optimizations engine 126, and used to create a digital twin based on the ontology 160 and the domain data 162. The digital twin may be created as a particular knowledge graph of the knowledge graphs 112. As described briefly above, the knowledge graph 112 may include a domain ontology knowledge graph created by the knowledge engine 124. The knowledge graph 112 may, additionally, or alternatively, include a probabilistic ontology graph model created by the probabilistic modelling and optimizations engine 126. In some implementations, the knowledge graph 112 may, additionally, or alternatively, include a decision optimization model created by the probabilistic modelling and optimizations engine 126 (e.g., the optimization engine). Additional details of the structure of knowledge graphs are described further herein with reference to FIGS. 2A-4.

The knowledge engine 124 may create the domain ontology knowledge graph based on the object types, semantic relationships, and other information specified in the ontology 160. As an illustrative example and referring to FIG. 2A, a block diagram illustrating exemplary aspects of a knowledge graph in accordance with aspects of the present disclosure is shown as a knowledge graph 200. The knowledge graph 200 includes nodes 210, 212 connected via an edge 214. The nodes 210, 212 are digital representations of physical assets (e.g., physical locations, devices, machines, processes, etc.) identified in a corresponding ontology and different nodes may be associated with different node types based on properties derived from the ontology. To illustrate using the simplified example shown in FIG. 2A, node 210 represents a first node type—a physical location, such as a warehouse or production facility—and node 212 represents a second node type—an asset, such as robot, present in the physical location corresponding to the node 210. The edges of the knowledge graphs may be determined based on the ontology and may be used to formalize semantic relationships within the knowledge graph. For example, in FIG. 2A the edge 214 indicates a semantic relationship between the nodes 210, 212, such as to indicate a robot represented by the node 212 is located at a physical location represented by the node 210, as indicated by the label “hasDevice” associated with the edge 214 (e.g., the edge 214 indicates the location corresponding to the node 210 has a device corresponding to the node 212). It is noted that the edges of the knowledge graph may be defined such that they point from one node to another node (e.g., from node 210 to node 212) or from a node to data, and the particular node an edge points to may be determined based on the semantic relationship information included in the ontology (e.g., the ontology 160 of FIG. 1).

In addition to nodes representing assets, other types of nodes may be provided in a knowledge graph, such as nodes representing attributes (e.g., an age of a machine or robot represented in the knowledge graph), processes steps (e.g., tasks performed by a machine or robot represented in the knowledge graph), entities (e.g., a manufacturer of a machine or robot represented in the knowledge graph), or other types of nodes. As described above, these nodes may be connected to other nodes via edges. For example, the knowledge graph 200 could be generated to include a task node (not shown in FIG. 2A) that is connected to the node 212 representing a robot via an edge that points from the node 212 to the task node to indicate that the robot performs the task associated with the task node. Similarly, the knowledge graph 200 could be generated (e.g., by the knowledge engine 124) to include an attribute node (not shown in FIG. 2A) that is connected to the node 212 representing a robot via an edge that points from the node 212 to the attribute node to indicate that the robot has the attribute associated with the attribute node. Likewise, the knowledge graph 200 could be generated to include an entity node (not shown in FIG. 2A) that is connected to the node 212 representing a robot via an edge that points from the entity node to the node 212 to indicate that the robot was produced by the entity associated with the entity node.

The knowledge graph 200 may also incorporate other types of data, such as historical data and metadata. To illustrate, node 212 is described in the example above as representing a robot that performs a task. Sensors or other devices may monitor performance of the task by the robot and generate data associated with performance of the task, such as the number of times the task was performed, whether the task was performed successfully or not, a duration of time required for the robot to complete the task, or other types of data. The dataset generated during the monitoring may be stored in the knowledge graph 200. Additionally, metadata may also be stored in the knowledge graph 200, for example, the physical location of where a certain data point is stored, and more specifically, which database on which server and what the IP address of the server is. Additional metadata can also include access privileges for certain users to this data which can be for a subset of the knowledge graph 200.

As a non-limiting example and with reference to FIG. 3, a block diagram of a knowledge graph in accordance with aspects of the present disclosure is shown as a knowledge graph 300. As explained above, the knowledge graph 300 may be generated by the knowledge engine 124 based on an ontology, such as the ontology 160 of FIG. 1. As shown in FIG. 3, the knowledge graph 300 includes nodes 310, 320, 330, 340, 350, 360, 370, 380, where node 310 represents an Application (e.g., a software application), node 320 represents a service (e.g., a service of the software application), node 330 represents infrastructure (i.e., infrastructure hosting or supporting the software application), node 340 represents software (e.g., software running the application), node 350 represents an operating system (e.g., an operating system of the software running the application), node 360 represents a configuration (e.g., a configuration of the software application), node 370 represents a user base (e.g., persons which connect, such as use or interact with, the software application), and node 380 represents traffic (e.g., traffic generated by the user base which connects with the software application).

The knowledge graph 300 also includes a series of edges 312, 314, 316, 318, 342, 372, 374 that connect different ones of the nodes 310, 320, 330, 340, 350, 360, 370, 380 to indicate semantic relationships among the nodes 310, 320, 330, 340, 350, 360, 370, 380. For example, edge 312 points from the node 310 (i.e., the application) to the node 320 (i.e., the service) to indicate the relationship between nodes 310, 320 is the application is hosted on the service. The edge 314 points from node 310 (i.e., the application) to the node 330 (i.e., the infrastructure) to indicate the relationship between nodes 310, 330 is that the application uses (e.g., operates on) the infrastructure. The edge 316 points from the node 310 (i.e., the application) to the node 350 (i.e., the software) to indicate the relationship between nodes 310, 350 is that the application runs on the software. The edge 318 points from the node 310 (i.e., the application) to the node 360 (i.e., the configuration) to indicate the relationship between nodes 310, 360 is that the application has configurations.

The edge 342 points from node 340 (i.e., the software on which the application runs) to the node 350 (i.e., the operating system) to indicate the relationship between nodes 340, 350 is that the software runs on the operating system. The edge 372 points from node 370 (i.e., the user base) to the node 310 (i.e., the application) to indicate the relationship between nodes 370, 310 is that the user base connects with the application. Similarly, the edge 374 points from node 370 (i.e., the user base) to the node 380 (i.e., the traffic) to indicate the relationship between nodes 370, 380 is that the user base generates traffic.

As a non-limiting example and with reference to FIG. 4, a block diagram of a knowledge graph in accordance with aspects of the present disclosure is shown as a knowledge graph 400. As explained above, the knowledge graph 400 may be generated by the knowledge engine 124 based on an ontology, such as the ontology 160 of FIG. 1. As shown in FIG. 4, the knowledge graph 400 includes nodes 410, 420, 430, 440, 450, 460, 470, 480, where node 410 represents a cloud service (e.g., a cloud-based software application), node 420 represents a cloud provider (e.g., a provider of the cloud service), node 430 represents an auto scaler (e.g., an automatic scaling program or algorithm for the cloud service), node 440 represents a load balancer (e.g., a load balancing program or algorithm for the cloud service), node 450 represents operating metrics (e.g., operating metrics to measure the performance of components, such as operating metrics for the virtual machines, the automatic scaler, or both), node 460 represents a virtual machine pool (e.g., a virtual machine pool for the data center), node 470 represents a data center (e.g., a data center associated with the cloud provider), and node 480 represents a virtual machine (e.g., a virtual machine of the data center).

As shown in FIG. 4, the knowledge graph 400 further includes nodes 432, 434, 436, 442, 452, 454, 456, 462, 482, 484, 486, where node 432 represents a delay threshold (e.g., a duration before engaging in scaling, such as activating the auto scaler), node 434 represents a scaling condition (e.g., a condition for performing scaling or an aspect thereof), node 436 represents a scaling interval (e.g., a duration of how often to perform or assess scaling or an aspect thereof), node 442 represents an algorithm (e.g., an algorithm for the load balancer). Node 452 represents a response time, node 454 represents a violation counter, and node 456 represents a request failure counter, such as metrics of the operation metrics. Node 462 represents thresholds for the virtual machine pool, such as a minimum and/or a maximum count of virtual machines for of the data center for the cloud service. Node 482 represents a configuration of the virtual machine, node 484 represents a startup delay of the virtual machine, and node 486 represents an activity state of the virtual machine. Nodes 484 and 486 may include or correspond to metrics of the virtual machine for the cloud service.

As shown in the example of FIG. 4, nodes 410, 420, 430, 440, 450, 460, 470, 480 may include or correspond to major or master (e.g., primary) nodes and nodes 432, 434, 436, 452, 454, 456, 462, 482, 484, 486 may include or correspond to lesser (e.g., secondary) nodes. The major or master nodes are all connected to one another directly or indirectly through another master node, and all of the lesser nodes are only connected to the other nodes via one other node, i.e., another master or major node. In the example of FIG. 4, the master nodes depict the class nodes in the graph, while the secondary nodes depict the properties related to class nodes.

The knowledge graph 400 also includes a series of edges 492 that connect different ones of the nodes of FIG. 4 to indicate semantic relationships among the nodes of FIG. 4. For example, node 410 has multiple edges 492 connecting node 410 to both of nodes 430 and 440, such as an edge to indicate the relationship between nodes 410, 430 is the cloud service has a sub-service of an auto scaler and to indicate the relationship between nodes 410, 440 is the cloud service has a sub-service of a load balancer.

Node 420 has multiple edges 492 connecting node 420 to both of nodes 410 and 470, such as an edge to indicate the relationship between nodes 410, 430 is the cloud provider provides a service to the cloud service and to indicate the relationship between nodes 420, 470 is the cloud provider is associated with the data center.

Node 430 has multiple edges 492 connecting node 430 to nodes 410, 450, and 470, such as an edge to indicate the relationship between nodes 430, 450 is the auto scaler makes enquires to the data center. The relationship between nodes 430, 410 was described above and the relationship between nodes 430, 470 is described with respect to node 470.

Node 430 has also multiple edges 492 connecting node 430 to nodes 432, 434, and 436, such as an edge to indicate the relationship between nodes 430, 432 is the auto scaler measures a delay threshold (e.g., monitors a delay condition), to indicate the relationship between nodes 430, 432 is the auto scaler measures a scaling condition (e.g., enforces a rule), and to indicate the relationship between nodes 430, 436 is the auto scaler measures a scaling interval.

Node 440 has multiple edges 492 connecting node 440 to nodes 410, 442 and 470, such as an edge to indicate the relationship between nodes 440, 442 is the load balancer runs on the algorithm and to indicate the relationship between nodes 440, 470 is the load balancer updates the data center. For example, the load balancer may update one or more operations and/or properties of the data center (e.g., a load on the data center itself or virtual machines (VMs) thereof or rules for adjusting loads between data centers or between VMs) based on the algorithm. The relationship between nodes 440, 410 was described above.

Node 450 has multiple edges 492 connecting node 450 to nodes 430 and 480, such as an edge to indicate the relationship between nodes 450, 430 is the operation metrics monitor the auto scaler and to indicate the relationship between nodes 450, 480 is the operation metrics record the virtual machine (e.g., metrics thereof).

Node 450 has multiple edges 492 connecting node 450 to nodes 452-456, such as an edge to indicate the relationship between nodes 450, 452 is the operation metrics have a response time metric, to indicate the relationship between nodes 450, 454 is the operation metrics have a violation count metric, and to indicate the relationship between nodes 450, 456 is the operation metrics have a request failure count metric.

Node 460 has an edge 492 connecting node 460 to node 462 to indicate the relationship between nodes 460, 462 is the virtual machine pool has specifications, such as a minimum and/or maximum count of virtual machines for the cloud service. Node 460 is also connected to node 470 by another edge described with reference to node 470.

Node 470 has multiple edges 492 connecting node 410 to nodes 420, 420, 440, 460, and 480. These edges 492 includes edges to indicate the relationship between nodes 470, 460 is the data center manages a pool of virtual machines, i.e., the virtual machine pool, and to indicate the relationship between nodes 470, 480 is the data center activates (e.g., initiates or instantiates) virtual machines. The edges with nodes 420, 430, and 440 have been discussed, and the other edge with 480 is discussed below with reference to node 480.

Node 480 has multiple edges 492 connecting node 480 to both of nodes 450 and 470, including multiple edge with node 470. such as an edge to indicate the relationship between nodes 480, 470 is the virtual machine belongs to the data center. The edge with node 450 and the other edge with node 470 have been discussed above.

Node 480 has multiple edges 492 connecting node 480 to nodes 482-486, such as an edge to indicate the relationship between nodes 480, 482 is the virtual machine has a configuration, to indicate the relationship between nodes 480, 484 is the virtual machine has a startup delay metric, and to indicate the relationship between nodes 480, 486 is the virtual machine has an activity state metric.

Referring back to FIG. 1, the domain ontology knowledge graph created by the knowledge engine 124 provides a qualitative representation of the ontology 160. For example, the domain ontology knowledge graph provides a representation of the real world assets represented by the ontology (e.g., the nodes of the domain ontology knowledge graph) and semantic relationships between the assets (e.g., the edges of the domain ontology knowledge graph). At this point, the domain ontology knowledge graph produced by the knowledge engine 124 enables explicit knowledge to be obtained from the domain ontology knowledge graph using logical inferences. This represents a simplified example that may be leveraged by the knowledge engine 124. In some implementations, the domain ontology knowledge graph created by the knowledge engine 124 may be customized or tuned in a manner to enable generation of digital twins that support specific more than one instance of a specific real world counterpart and that are not generated in a static manner.

As a non-limiting example and with reference to FIG. 2B, a block diagram of a knowledge graph in accordance with aspects of the present disclosure is shown as a knowledge graph 220. As explained above, the knowledge graph 220 may be generated by the knowledge engine 124 based on an ontology, such as the ontology 160 of FIG. 1. As shown in FIG. 2B, the knowledge graph 220 includes nodes 230, 240, 250, 260, 270, 280, where node 230 represents a manufacturer (M), node 240 represents a robot (R), node 250 represents an age (A) (i.e., an attribute), node 260 represents a task (T), node 270 represents a status (S), and node 280 represents a duration (D). The knowledge graph 220 also includes a series of edges 232, 242, 244, 262, 264 that connect different ones of the nodes 230, 240, 250, 260, 270, 280 to indicate semantic relationships among the nodes 230, 240, 250, 260, 270, 280. For example, edge 232 points from the node 240 (i.e., the robot) to the node 230 (i.e., the manufacturer) to indicate the relationship between nodes 230, 240 is the robot was manufactured by the manufacturer. The edge 242 points from node 240 (i.e., the robot) to the node 250 (i.e., the age attribute) to indicate the relationship between nodes 240, 250 is that the robot has an age. The edge 244 points from node 240 (i.e., the robot) to the node 260 (i.e., the task) to indicate the relationship between nodes 240, 250 is that the robot performs the task. The edge 262 points from node 260 (i.e., the task) to the node 270 (i.e., the status) to indicate the relationship between nodes 260, 270 is that the task has a status. Similarly, the edge 264 points from node 260 (i.e., the task) to the node 280 (i.e., the duration) to indicate the relationship between nodes 260, 280 is that the task has a duration.

Referring back to FIG. 1, as part of the process for creating a knowledge graph (e.g., the knowledge graph 220 of FIG. 2B), the functionality of the knowledge engine 124 may be leveraged to incorporate data from one or more data sources 150. For example, the data sources 150 may include sensors or devices 152 (hereinafter “sensors 152”), systems 154, or other sources of data (e.g., the database(s) 138, etc.). The sensors 152 may include Internet of things (IoT) devices, temperature sensors, motion sensors, weight sensors, pressure sensors, network traffic sensors, reading devices (e.g., magnetic card reader devices, radio frequency identified (RFID) devices, chip card readers, or other types of devices configured to read information from a device scanned in proximity to the reading device(s)), fuel sensors, accelerometers, gyroscopes, or other types of sensors configured to detect information of interest with respect to a real world counterpart. In addition, the sensors 152 may include other types of devices that may provide information of interest for use in analysis and understanding using a digital twin, such as controllers, navigation systems, communication devices, or other types of devices that may collect or generate information related to operations or functioning of the real world counterpart of a digital twin. Furthermore, the systems 154 may include enterprise resource planning (ERP) systems or other types of systems that may contain information related to the real world counterpart corresponding to a digital twin being created using the system 100.

As can be appreciated from the foregoing, information pertaining to a real world counterpart of a digital twin can include many different data sources 150 and types of data. Rather than attempting to design a digital twin generation platform that is specifically configured for specific data types and data sources, the present disclosure provides a data ingestion engine 122 that provides functionality for obtaining or receiving information from a variety of data sources and storing the data in the one or more database 110. Once stored, the knowledge engine 124 may be used to create or extend the domain ontology knowledge graph (e.g., the knowledge graph 220 of FIG. 2B) to incorporate the data obtained by the data ingestion engine 122. For example, data obtained by the data ingestion engine 122 in connection with the knowledge graph 220 of FIG. 2B may include information associated with one or more types of robots corresponding to node 240 (e.g., high-speed robots, ultra-maneuverable robots, high-payload robots, extended-reach robots, etc.), the manufacturer of each type of robot, the age of the robots, tasks that can be performed by each different robot, information regarding a duration for instances of each robot performing a corresponding task, information regarding a status of each task (e.g., completed/not completed, success/fail, etc.), or other types of information.

It is to be understood that the exemplary types of information described above in connection with the information represented by the knowledge graph 220 of FIG. 2B that may be collected by the data ingestion engine 122 have been provided for purposes of illustration, rather than by way of limitation and that other types of data may be ingested into the computing device 102 by the data ingestion engine 122 in connection with the creation of digital twins involving other types of real world counterparts. For example, a manufacturing facility may be represented as a digital twin and the data ingestion engine 122 may obtain information associated with various aspects of the manufacturing process, such as the order in which the manufacturing process is performed, the materials and/or machinery or equipment involved in each stage of the manufacturing process, the sources of the materials, the storage locations of the materials, operations performed by the machinery or equipment during the manufacturing process, packaging of the products once produced, or any other types of steps, processes, or features that may be needed to model the manufacturing process as a digital twin. As another example, a healthcare services provider may be represented as a digital twin and the data ingestion engine 122 may obtain information associated with various aspects of the healthcare services process, such as the patients treated by the healthcare services provider, the operations or treatments performed at various buildings or centers, the medical supplies used in the treatment or diagnosis of medical conditions by healthcare service personnel, medical records generated during the course of healthcare services, or any other types of steps, processes, or features that may be useful to model the healthcare services as a digital twin.

As another example, the computing device 102 may also enable digital twins (e.g., each layer of or the entirety of) to be created in a system of systems-type manner whereby multiple digital twins are created and combined into a digital twin of digital twins, such as a digital twin of a process for producing the materials, a materials acquisition process, a manufacturing process, shipping or logistics process and/or system, and other aspects of the life cycle from producing materials, to manufacturing products, to delivering the products to end users or consumers. Such system of systems-type digital twins may be used to represent complex workflows, processes, equipment, and the like, thereby enabling the creation of digital twins for entire ecosystems, which is a capability that is currently not available using existing digital twin platforms and tools. During creation of such complex digital twins as those described above, many different types of data may be obtained for incorporation into knowledge graphs generated by the knowledge engine 124.

In some aspects, the functionality of the data ingestion engine 122 may be provided via an API 129 that enables a user to specify the data sources 150 of interest (i.e., which data sources of the data sources 150 from which to obtain data for a digital twin), the types of data to be obtained, and a frequency at which the data should be obtained. For example, the knowledge graph 220 of FIG. 2B relates to digital twin of a robot that performs tasks. In the context of the digital twin (e.g., the knowledge graph), the robot may be any type of robot and the tasks performed by the robot may vary according to a particular robot of interest. For example, the knowledge graph 300 of FIG. 3 relates to digital twin of a software application that performs tasks. In the context of the digital twin (e.g., the knowledge graph), the software application may be any type of software application and the software application performed by the robot may vary according to a particular software application of interest. For example, the knowledge graph 400 of FIG. 4 relates to digital twin of a network that performs tasks (e.g., hosts software applications). In the context of the digital twin (e.g., the knowledge graph), the network may be any type of network and the tasks performed by the network may vary according to a particular network of interest. In this manner the digital twin may be independent of any specific real world counterpart represented by the knowledge graph (e.g., a layer thereof). To facilitate use of the digital twin for analysis and understanding of the real world counterpart, data associated with a particular real world counterpart or multiple real world counterparts (e.g., one or more robots, one or more software applications, one or more networks,) may be incorporated into the knowledge graph 220.

By incorporating collections of data from the data sources 150 into the knowledge graph (e.g., a knowledge graph, or a particular layer thereof, of the knowledge graphs 112), the knowledge engine 124 enables additional types of information to be derived from the digital twin, such as information quantifying relationships between different pairs of nodes. Additionally or alternatively, the information of the domain ontology knowledge graph may be used by the probabilistic modelling and optimizations engine 126 (e.g., the probabilistic modelling engine) to generate probabilistic information and/or a probabilistic graph model, and to optionally, update the knowledge graph (e.g., the domain ontology thereof). In some implementations, the probabilistic graph model may include or correspond to a particular layer of the knowledge graph, such as when the graph is a multi-layer probabilistic knowledge graph. In such knowledge graphs or layers thereof, the edges may represent semantic dependencies (e.g., “manufactured_by”, “has_a”, “performs”) or may represent statistical dependencies (e.g., “{‘relation’: ‘depends_on’}”). Exemplary aspects of converting a knowledge graph into a probabilistic graph model are described in commonly owned U.S. patent application Ser. No. 17/681,699, filed Feb. 25, 2022, and entitled “SYSTEM FOR PROBABILISTIC REASONING AND DECISION MAKING ON DIGITAL TWINS,” the contents of which are incorporated herein by reference.

The knowledge graph(s) 112 generated by the knowledge engine 124, the probabilistic modelling and optimizations engine 126, and the ontology feedback engine 128 enable creation of digital twins that provide improved capability and insights that facilitate improved analysis and understanding to be obtained with respect to the real world counterparts represented by the digital twins through enhanced querying. To illustrate, instead of querying a model represented by multiple knowledge graphs individually and having to somehow aggregate the results to provide the desired insights, a query 114 may be performed on a updated or heterogenous knowledge graph of the knowledge graphs 112 in its entirety (e.g., as a whole) to return semantic information, probability distributions or analysis, decision making and optimization information, or any combination thereof, through a single query 114 that returns more accurate information faster and more efficiently through use of a combined or conjoined digital twin that represents an entire system or a modified system as compared to separately performing multiple individual knowledge graph-specific queries and attempting to make sense of the multiple results. For example, a query may be defined and used to analyze software development related questions. To illustrate, the query may include: What will happen when a service is migrated to or interacts with a cloud provider or cloud service? Executing the query against the heterogenous knowledge graph representing the digital twin returns information that indicates an outcome or outcomes of migrating the service to the clouds.

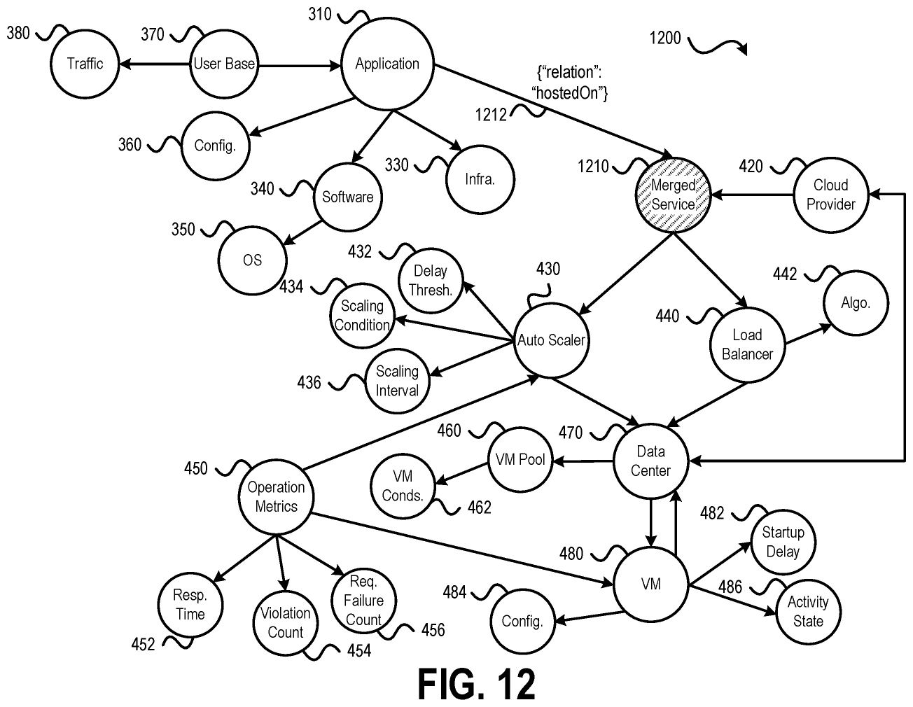

Additional examples of queries are described further herein with reference to the knowledge graph of FIG. 12, which may be generated by the process of FIG. 5. The query 114 may be generated via the API 129 that provides query building functionality to enable the computing device 102 to receive user input indicating one or more query parameters and to generate the query 114 based on the user input. Additionally or alternatively, the computing device 102 may generate and display a GUI that facilitates the query building, that displays one or more query results, or both. In some implementations, the computing device 102 generates a control signal based on a query result and transmits the control signal to the real world counterpart of the digital twin to cause performance of one or more actions based on the query results. As a non-limiting example, the computing device 102 may transmit a control signal that causes an estimation of the performance of the service operating in the cloud described with reference to FIGS. 2A-4 and 12 based on a query result that indicates an outcome of migrating the service to the clouds. To illustrate, the computing device 102 may transmit a control signal that causes an estimation of a number of virtual machines used by the service operating in the cloud described with reference to FIGS. 2A-4 and 12 based on a query result that indicates how many virtual machines will be used at a particular time, at a peak load, with certain load balancing and/or scaling criteria or a combination thereof

In a particular implementation, a system that supports creating digital twins is disclosed. The system includes a memory (e.g., 106) and one or more processors (e.g., 104) communicatively coupled to the memory. The one or more processors are configured to obtain a dataset that includes an ontology (e.g., 160) and domain data (e.g., 162) corresponding to a domain associated with the ontology. The one or more processors are also configured to generate a knowledge graph (e.g., 112) based on the ontology and the domain data. The knowledge graph represents a digital twin of a real world counterpart (e.g., 154). To generate the knowledge graph the one or more processors are configured generate the knowledge graph based on the ontology and the domain data. Optionally, the one or more processors may be configured to automatically construct the knowledge graph based on the ontology and the domain data. In some implementations, the knowledge graph is further generated or revised based on additional data, such as hierarchy data. For example, the one or more processors are further configured to run a query (e.g., 114) against the hierarchy information 111 to obtain a query result. The query result includes one or more portions of the hierarchy information 111, such as a digital twin structure information, ontology information, and interconnection information. The hierarchy information 111 enables standardization for categories of schema and rules and interconnections for business domain and enables normalized or standardized outputs. After the query result is received, the one or more processors may generate the knowledge graph based on the query result and hierarchy information 111, or the one or more processors may first generate the knowledge graph based on the ontology and the domain data, and then revise the knowledge graph based on the hierarchy information 111.

As described above, the system 100 the functionality for generation of digital twins in an ontology-driven manner with less user input and that support improved querying capabilities as compared to other digital twins or individual information graph and probabilistic graph model-based technologies. For example, the system 100 enables a user to provide the hierarchy information 111 to be used to update or generate a knowledge graph of the knowledge graphs 112 as part of a digital twin creation process. The system 100 may automatically update the knowledge graph with the hierarchy information 111, such as by updating the node and relationships of the knowledge graph with the twin stricture, ontology and interconnections of the hierarchy information 111 to generate an updated knowledge graph. The system 100 may then engage in an adaptive ontology feedback loop or process to update one or more knowledge graphs. The system 100 can use the updated knowledge graph, such as by processing the knowledge graph with the ontology feedback engine 128. The ontology feedback engine 128, such as the components or engine thereof may process the updated knowledge graph to generate a recommendation 164 for revising the updated knowledge graph, updating other knowledge graphs or updating the hierarchy information 111.

This technique allows for automated and less intensive management and updating of knowledge graphs, which greatly reduces the burden of managing digital twins. The technique also allows for knowledge graph/digital twin merging to create larger heterogonous digital twins from two separate digital twins to simulate or model the combination of two systems. As such, the system 100 provides functionality for generating and updating digital twins that automates the maintenance and update process for digital twins. As such, the system 100 provides for the creation and use of digital twins to model larger and more complex real world counterparts in a manner that enables improvements in software development and system testing and simulation.

It is noted that the system 100 (e.g., the data ingestion engine 122, the hierarchy engine 123, the knowledge engine 124, the probabilistic modelling and optimizations engine 126, and the ontology feedback engine 128 of the computing device 102 of FIG. 1) may leverage various technologies to support the functionality described above with reference to FIGS. 1 and 2A-4, and below with reference to FIGS. 5-13. For example, the computing device 102 may utilize APIs to obtain information utilized to generate digital twins (e.g., ontologies, data from the one or more data sources 150 of FIG. 1, etc.) and to provide information derived from digital twins to users. Furthermore, while the functionality described herein has been primarily with reference to generating digital twins using the computing device 102 or a cloud-based implementation of the computing device 102 (e.g., the cloud-based system 142 of FIG. 1), it is to be appreciated that the functionality for generating digital twins may also be provided local to a user device (e.g., the computing device 130 of FIG. 1). In such an implementation the user device may execute an application for generating digital twins in accordance with aspects of the present disclosure, and the application may be stored as instructions (e.g., the instructions 136) in a memory (e.g., the memory 134) of the user device.

It should also be understood that the present disclosure provides a generalized platform that includes a suite of tools that facilitate rapid creation of digital twins for specific use cases and that may be readily reused or modified for additional use cases, thereby providing more flexibility for modelling real-world counterparts using digital twins and decoupling the digital twin platform and tools from the use cases to which the platform and tools could be applied (e.g., unlike traditional digital twin platforms and tools, the disclosed systems and techniques for producing digital twins are not restricted to particular real-world counterparts, use cases, or analysis). The functionality of the system 100 also provides the advantage of generating digital twins that utilize a single data representation (e.g., data and artificial intelligence (AI)) in which the multiple types of models, such as a data model (e.g., the domain ontology knowledge graph of the first layer), the statistical (AI/ML) model of the data (e.g., the probabilistic ontology graph model of the second layer), and the optimization model (e.g., the decision optimization model of the third layer) are tightly coupled. As such, there is no need to move the data out of the platform to run analytics. Also, since the various models are tightly integrated with the data, the data may be expressed both deterministically and probabilistically, which speeds up computation while also reducing the computational resources required to run the analytics. Similar reductions in resources and improvements in computation time may be experienced due to tightly coupling the decision optimization layer with the probability distributions and likelihood functions of the lower second layer.

Referring to FIG. 5, a diagram of an example process of updating a digital twin is shown as a graph 500. The example process shown in FIG. 5 may include or correspond to an Ontology Driven, Self-Adaptive Digital Twin for Evolving Heterogeneous Cyber-Physical Systems. The process shown in graph 500 includes multiple components (e.g., component extractor 510) which perform actions (e.g., component replication determination at 512) to complete the process and provide feedback. The process shown in graph 500 may be performed by other devices, described herein, such as the computing device 102 of FIG. 1. For example, the ontology feedback engine 128 (including components thereof) may perform one or more actions of the process.

The process may include one or more inputs, such as a schema 590, an ontology 592, on premise agents 594, twin artifacts 596, or any combination thereof. The schema 590, schema information or data, may include or correspond to a schema for generating a knowledge model, such as a knowledge model schema, and may be used to generate a knowledge model, such as the knowledge models and knowledge model graphs described in FIGS. 1-4. The schema 590 may include to architecture schema, application schema, etc., and may be generated or defined manually by an expert in the field or a person familiar with the cyber-physical system.

The ontology 592, ontology information or data, may include or correspond to software ontology, such as software development Lifecyle (SDLC) ontology, and may be used to generate a knowledge model, such as the knowledge models and knowledge model graphs described in FIGS. 1-4. The ontology 592 may include to architecture schema, application schema, etc., and may be generated or defined manually by an expert in the field or a person familiar with the cyber-physical system.

The on-premise agents 594, such as on-premise agent information (e.g., information regarding controlled assets), may include or correspond to cyber-physical components of the system, and may be used to generate components of the knowledge model, such as the knowledge models and knowledge model graphs described in FIGS. 1-4. As illustrative, non-limiting examples, the on-premise agents 594 may include or correspond to tools, databases, control systems, etc.

The artifacts 596, artifacts information or data, may include or correspond to digital twin architecture artifacts, and may be used to generate components of the knowledge model, such as the knowledge models and knowledge model graphs described in FIGS. 1-4.

Additionally or alternatively, the process may include other inputs. For example, the process may include application information of an application working environment and its dependencies. This application information may be provided by the application owner or a third party and provides the application working specifications and architecture depicting its control/data flow with among the application artefacts as well as with the data units. As another example, the process may include data sources, such as the details of the data individuals (instantiated data points depicting the actual value in the schema). The data source information may be provided by the data source owner or a third party.

The process of graph 500 includes a plurality of components configured to interact with one another and perform certain actions of the process. As illustrated in the example, of FIG. 5, the components includes a knowledge model instantiator 502, a data analyzer 506, an architecture reader 508, a component extractor 510, knowledge model query 514, similarity determination 518, component rank calculator 522, cluster component grapher 526, and ontology adaptive feedback engine 530. The components may preform actions of the process at 512, 516, 520, 524, 528, and 532.

During operations of the process of graph 500, the knowledge model instantiator 502 generates a knowledge model 504. The knowledge model 504 may include or correspond to a digital twin structure with ontology and interconnect information. The knowledge model 504 may be generated based on a variety of inputs, including optionally some data which has been manually gathered, curated, or identified.

In some implementations, instantiating a knowledge model includes defining an architecture schema, standards and a hierarchical structure/ontologies around application specific artifacts specific to key metrics (e.g., KPIs) of the digital twin structures. In a particular implementation, this may be a manual operation performed by a person with working knowledge of the cyber-physical systems.

For example, a Subject Matter Expert (SME) may identify various categories of schema, rules, and interconnections of a business domain for standardization and identify interconnections between two siloed digital twin graphs. The SME may also identify and extend standard ontologies or standardized ontology formats (e.g., Provenance (PROV) ontology standard) to record and identify the operations performed to normalize the tool outputs. The use of standard or PROV ontologies may further increase transparency and interoperability in the system.

Using the application's schemas, a knowledge model is generated or instantiated with the information received by the knowledge model instantiator 502. As illustrated in the example of FIG. 5, the knowledge model instantiator 502 generates the knowledge model 504 based on the schema 590 and the ontology 592.

The data analyzer 506 receives information regarding the on-premise agents 594 and processes the information to generate an output which is provided to a component extractor 510. Optionally, the data analyzer 506 may also receive knowledge model information, such as knowledge model 504. For example, the component extractor 510 the data analyzer 506 may receive digital twin structure information, interconnect information, or both, and may generate the output based on this additional information. The output may include or correspond to component related information, such as information for identifying a new component or updating or revising an existing component.

The architecture reader 508 receives the information of the artifacts 596 and processes the information to generate an output which is provided to the component extractor 510. The output may include or correspond to component related information, such as information for identifying a new component or updating or revising an existing component.

As illustrated in the example of FIG. 5, the process includes the component extractor 510 performing component replication determination at 512, such as determining the relevant components from the data source to replicate. For example, the component extractor 510 receives outputs from the data analyzer 506 and the architecture reader 508, and generates components based on the received information (e.g., from received application ratifications and data sources). For example, the component extractor 510 extracts and identifies components from the on-premise agents using the artifacts of the digital twin architecture.

Leveraging the application architecture (if available) and the data sources, the component extractor 510 may apply keyword extractions to extract the relevant data points out of the architecture schema. To determine the dynamic flow between the components (there after addressed as edges), dynamic analysis on the flow of data through APIs, database connection points, HTTP calls to other services and create a component graph. Application architecture may be modeled by a weighted directed graph, called a component graph. A node in a graph represents an application artifact, and a directed edge (E), such as edge from node x to node y of the notation E_{xy}, represents a use relation, meaning that component x uses or relies on component y.

As illustrated in the example of FIG. 5, the process includes a knowledge model query at 514, such as retrieving a knowledge hierarchy model for use in generating or refining a knowledge graph of a digital twin. The query to the knowledge model may identify the domain knowledge of the application architecture. To illustrate, the knowledge hierarchy model or information thereof may be used to enhance the interconnections between component graph and fill in the necessary data graphs. After the knowledge model query at 514, the process may include relation determining and labeling at 516 using the knowledge model information. For example, the relations/correlations among the components may be determined and labeled to generate a knowledge graph or digital twin.

As illustrated in the example of FIG. 5, the process includes the similarity determiner 518 performing component identification at 520, to identify tightly coupled twin components. For example, the similarity determiner 518 may perform or enable similarity determinations by processing components of the digital twin. To illustrate, the similarity determiner 518 may process nodes of the knowledge graph by encoding to determine data points. The data points correspond to the nodes of the knowledge graph and may then enable determination of the similarity between the nodes.

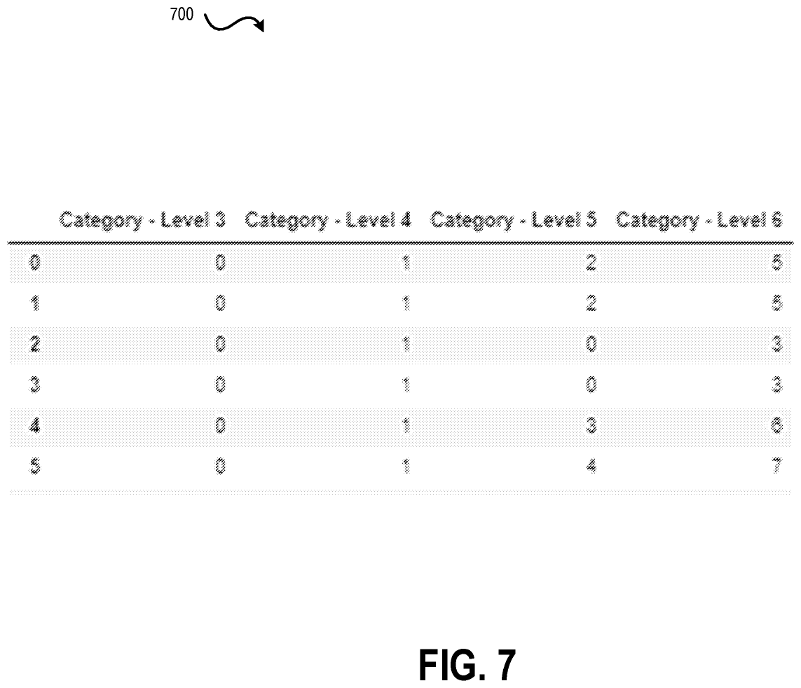

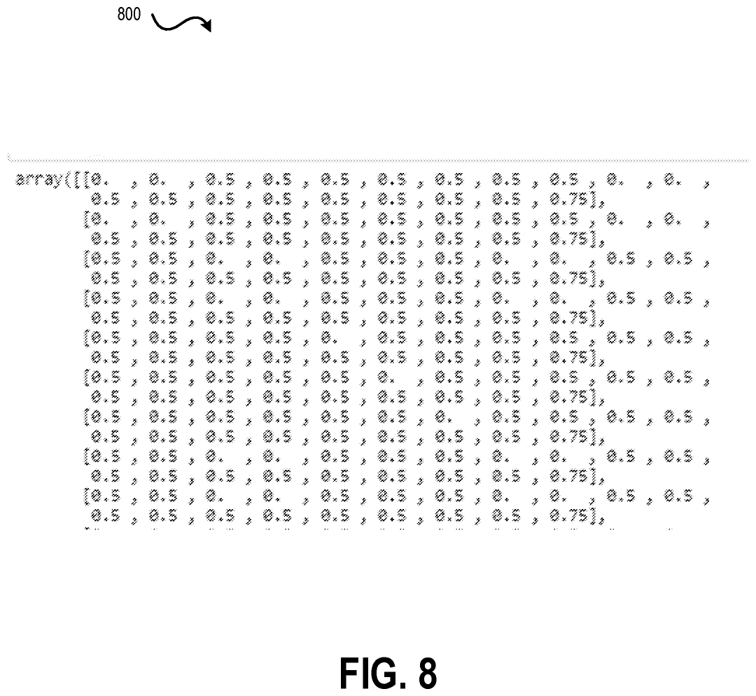

Details of the similarity determiner 518 and the performance of component identification at 520 are described further with reference to FIGS. 7 and 8.

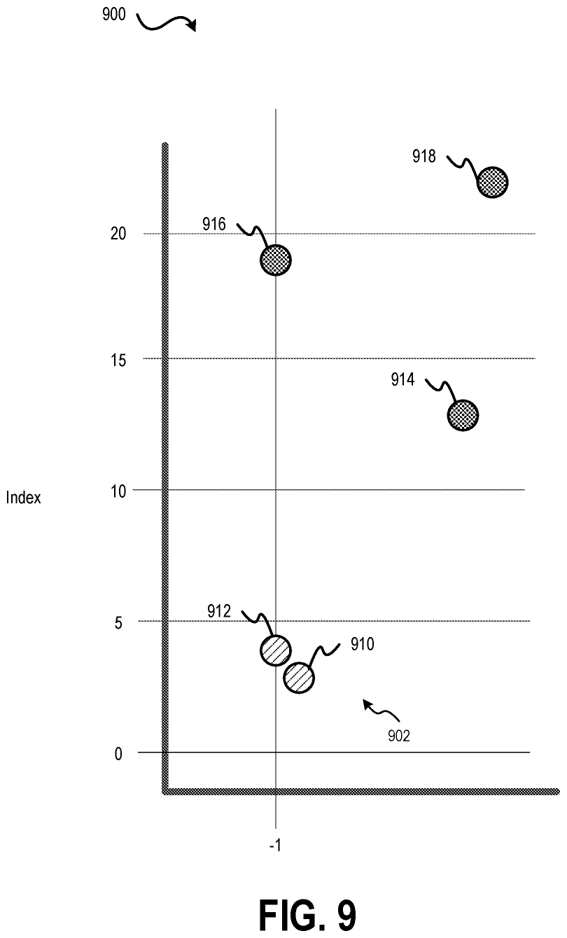

As illustrated in the example of FIG. 5, the process includes the component rank calculator 522 performing component rank calculation and determining correlation methods at 524. For example, the component rank calculator 522 may cluster nodes or application artifacts into groups using a clustering method or algorithm. To illustrate, the component rank calculator 522 may use a clustering method or algorithm that utilizes both density and distance (e.g., density and distance variables or thresholds). As an illustrative example, the component rank calculator 522 may use DBSCAN clustering to generate groups of components and identified clusters of components within the grouped or sorted components. DBSCAN clustering may help identify closely related components and relationships and group them together. One alternative clustering method is k-means. Details of the component rank calculator 522 calculating component ranks and determining correlation methods at 524 are described further with reference to FIGS. 8 and 9.

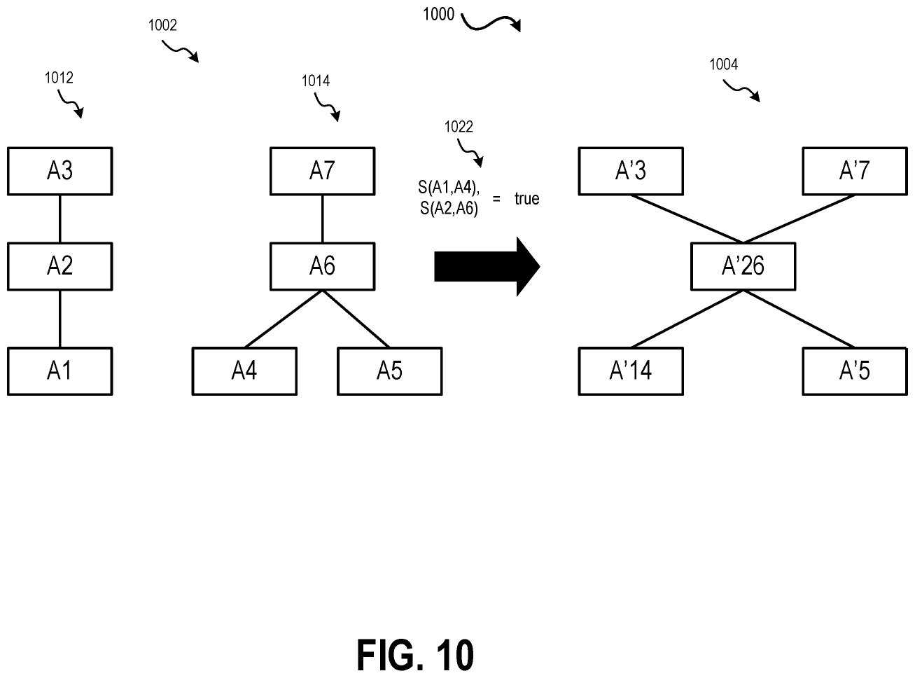

As illustrated in the example of FIG. 5, the process includes cluster component grapher 526 performing clustering operations on the components and determining clustering methods to cluster relevant data and twin information into the graphs with relationships at 528. For example, the cluster component grapher 526 may generate graphs of the clustered or sorted nodes or application artifacts and identify relationships and clusters of the grouped and sorted nodes/components. To illustrate, the cluster component grapher 526 may use different thresholds or knowledge schemas to identify similar components of a cluster and similar relationships of a cluster. The cluster component grapher 526 may optionally, determine which methods or thresholds to use for performing cluster graph evaluation. Details of the cluster component grapher 526 clustering components and determining clustering methods at 528 are described further with reference to FIGS. 9 and 10.

As illustrated in the example of FIG. 5, the process includes ontology adaptive feedback engine 530 performing ontology adaptive feedback loop operations determining a recommendation 532. The recommendation 532 includes a node update, such as update information for updating a node or a relationship. The recommendation 532 may include updating, merging or conjoining one or more nodes, one or more edges (e.g., relationships), or a combination thereof, of the digital twins. As an illustrative example, based on the clusters identified, the Service node, node 420, of the Application Digital Twin is recommended to be merged with the Cloud Service node, node 410, of the Cloud Digital Twin. The merging of these nodes may update the respective digital twins while still keeping each individual digital twin intact, generate a new larger combined (e.g., system) digital twin based on both the Application and Cloud Service digital twins, or both.

As another illustrative example, based on the clusters identified, an edge of the Application Digital Twin is recommended to be merged with an edge of the Cloud Digital Twin. The merging of these edges may update the respective digital twins will still keeping each individual digital twin intact, generate a new larger combined (e.g., system) digital twin based on both the Application and Cloud Service digital twins, or both.

The process and recommendation 532 may enable maintaining and facilitating heterogenous digital twins with ontologies. This will ensure seamless scaling of the application structure, targeted insights, and abstracted preview of the end-to-end system. To keep up with the ever-changing data intensive twins, ontologies will provide a core base for standardization, correlation and abstraction which will facilitate easy binding with the dynamic nature of these heterogenous twins.

Additionally, or alternatively, the recommendation 532 may include updating, merging or conjoining one or more nodes, one or more edges, or a combination thereof, of the knowledge model. Similar to the examples identified above, the recommendation 532 may indicate to merge the service 320 and the cloud service 410 nodes of the knowledge model or merge two edges of the knowledge model.

When the recommendation indicates to update both the digital twins and the knowledge model, the recommendation may indicate to update the digital twins first, the knowledge model first, or both at the same time. For example, the system may output or send a joint recommendation indicating to update both, or the system may output or send a first recommendation to update one and then later output or send a second recommendation to update the other. Alternatively, in some implementations where the recommendation may indicate to only update one of the digital twins or the knowledge model the, the system may later update the other, non-updated graph based on the updated graph. To illustrate, the recommendation may indicate to update the digital twins, and then one or more of the updated digital twins may be used to update the knowledge model.

Updating the two digital twins enables increased functionality and accuracy with respect to the two particular systems and digital twins by automated means. Updating the knowledge model enable increased functionality and accuracy for the system as a whole when assessing and updating other digital twins. Thus, a single query, which optionally includes elements corresponding to multiple types of information, may be executed against an updated or combined knowledge graph which represents multiple individual systems, to enable the retrieval of more accurate results that include simulation of multiple complex systems, thereby providing more robust and useful results to a user. Additionally, concurrently accessing multiple layers of a multi-layer probabilistic type knowledge graph to retrieve the query results may be faster than querying multiple different independent models and may provide more unified and integrated, and thus more meaningful, results without additional aggregation or processing.

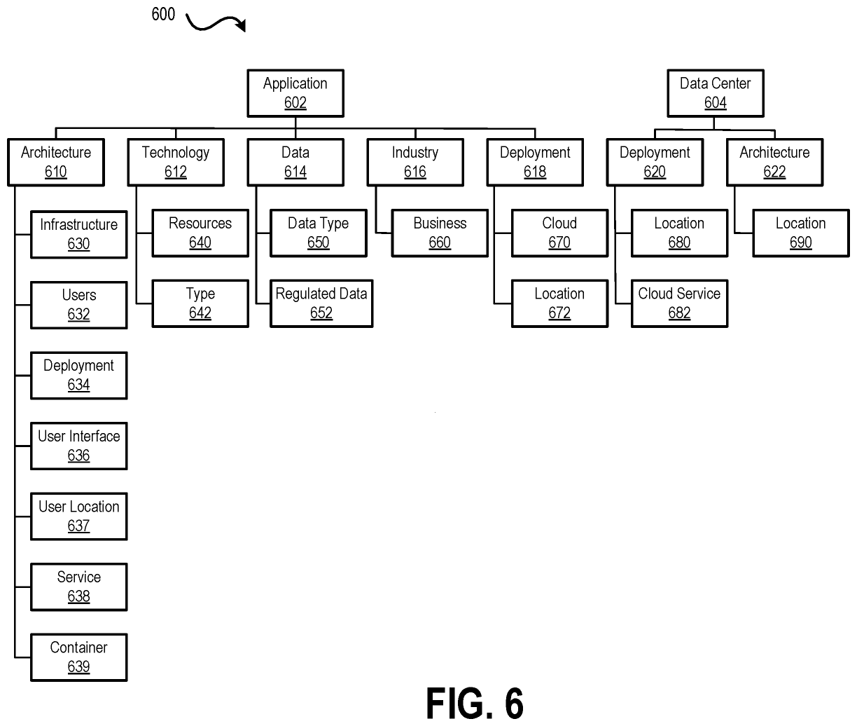

Referring to FIG. 6, an example of a knowledge hierarchy model according to one or more aspects of the present disclosure is shown as knowledge hierarchy model 600. The knowledge hierarchy model 600 may provide a syntactic relationship, a semantic relationship, or a combination thereof, of a real world counterpart represented by a digital twin, and the knowledge hierarchy model 600 may be used to create a knowledge graph and digital twin. In some implementations, the knowledge hierarchy model 600 may include or correspond to the hierarchy information 111 of FIG. 1 and/or a layer of the knowledge graph of FIGS. 1-4.

In the example of FIG. 6, the knowledge hierarchy model 600 corresponds to a hierarchy structure for or associated with the knowledge graphs of FIGS. 3 and/or 4. The knowledge hierarchy model 600 includes a plurality of related components or elements (e.g., application artifacts) arranged in various hierarchical relations. The components or elements of the knowledge hierarchy model 600 may include or correspond to nodes of the knowledge graphs.

In the specific example of FIG. 6, the knowledge hierarchy model 600 includes two top level components or elements, application 602 and data center 604. Each of the top level components are not related to each other, at this time in this implementation, but are related to various other sub-elements or lower level elements. For example, the application 602 includes or is related to components 610-618, specifically to architecture 610, technology 612, data 614, industry 616, and deployment 618. Each of the components 610-618 are related to each other and one or more sub-elements. Architecture 610 includes or is related to components 630-639, specifically to infrastructure 630, users 632, deployment 634, user interface 636, user location 637, service 638, and container 639. Technology 612 includes or is related to components 640 and 642, specifically to resources 640 and type 642. Data 614 includes or is related to components 650 and 652, specifically to data type 650 and regulated data 652. Industry 616 includes or is related to component 660, specifically to business 660. Deployment 618 includes or is related to components 670 and 672, specifically to cloud 670 and location 672.

For example, the data center 604 includes or is related to components 620 and 622, specifically to deployment 620 and architecture 622. Each of the components 620 and 622 are related to each other and one or more sub-elements. Deployment 620 includes or is related to components 680 and 682, specifically to location 680 and cloud service 682. Architecture 622 includes or is related to component 690, specifically to location 690.

The knowledge hierarchy model 600 may include interconnects (represented as lines) between component or elements of the knowledge hierarchy model 600 (that may correspond to or indicate relationships or edges of the knowledge graph) which are building blocks in the formation of digital twins and which are formed by the ontologies. As an illustrative example, the data center 604 may be interconnected to the sub-elements in that the data center 604 is deployed (e.g., deployment 620) at a location (e.g., location 680) which provides a cloud service (e.g., cloud service 682) and has a specific architecture (e.g., architecture 610) at that location (e.g., location 690). Utilizing the knowledge hierarchy model 600 to guide generating and updating knowledge graphs may enable adaptive digital twins.

Referring to FIG. 7, a similarity measurement graph according to one or more aspects of the present disclosure is shown as a similarity measurement graph 700. A similarity measurement graph, such as similarity measurement graph 700, may include or correspond to a n by n table of values where “n” represents the number of digits used in encoding of the data points (e.g., artifacts of the digital twin). The table represents a plurality of data points. The data points are generated by converting the identified artifacts of the digital twin, such as the nodes of the knowledge models of FIGS. 3 and 4, using an encoding scheme, such as one-hot encoding, and the knowledge model hierarchy. In other implementations, other types of encoding may be used, such as binary encoding, target encoding, count encoding, etc. In the example of FIG. 7, the similarity measurement graph 700 is a 5 by 5 table of values where 5 digits are used to encode of the data points. In other implementations, other size tables may be used depending on number of digits used in encoding of the data points corresponding to the elements of the digital twin.

A first column of the table indicates a specific node or element, such as elements 1-5. The second through fourth columns represent different categories, such as Levels 3-6, and indicate the data points for the nodes or elements of the first column for the different categories (e.g., levels). In some implementations, the levels may include or correspond to levels of the knowledge model hierarchy.

In some implementations, the data points may enable determination of similarity values between the components or artifacts of the digital twins or nodes of the knowledge model. For example, the data points may enable performance of a similarity measurement and similarity measurements or values when plotted on a graph. As an illustrative example, the data points of the second through fourth columns of the similarity measurement graph 700 may be plotted on a graph, and a Gowers' distance is calculated between each of the data points to determine the similarity between each of the data points. The similarity between each of the data points indicates a similarity between the corresponding artifact, component or node of the respective graph or model. For calculation of the Gowers' distance, one-hot encoding schemes may be used to enable understanding and depiction of the hierarchical structure.

Similarity of any two nodes (components) v1 and v2 may be determined by application of a logical function, such as S(v1,v2). Thus, if v1 and v2 are similar components, the outcome of the logical function (S(v1,v2) is true, otherwise it is false. The relation defined by the logical function S is an equivalent relation on V, where V is the set of components (nodes or edges). This relation enables partition of components V into a set of equivalent classes, composing the quotient set V′, where V′ is the set of combined components in V. Several independent subgraphs in the component graph may be merged into one, and the characteristics of each subgraph can be propagated to other subgraphs based on the similarity determination.

Referring to FIG. 8, a component ranking mechanism according to one or more aspects of the present disclosure is shown as a component ranking mechanism 800. The component ranking mechanism 800 corresponds to a portion of an image of a Gowers' distance matrix generated based on calculating the Gowers' distance based on the similarity measurement graph 700 of FIG. 7. Gowers' distance can be used to measure how different two records are. The records may contain combination of logical, categorical, numerical or text data. The distance is always a number between 0 (identical) and 1 (maximally dissimilar). Gowers' distance is computed as the average of partial dissimilarities across individuals.

As shown in FIG. 8, the component ranking mechanism 800 includes an array of a plurality of sets of 20 elements, where a value of each element ranges from 0 to 1. The component ranking mechanism 800 shows nine (9) sets of 20 elements/values. The 20 elements/values in each set corresponds to the 20 data points of the similarity measurement graph 700 (i.e., 4 columns by 5 rows of similarity data points for the 5 elements). The computed Gowers' distance, and corresponding weights, may be used for component clustering, as described with reference to FIG. 9.

Referring to FIG. 9, a clustered component graph according to one or more aspects of the present disclosure is shown as a clustered component graph 900. A clustered component graph, such as clustered component graph 900, may be generated by the component rank calculator 522 or the cluster component grapher 526. For example, based on the weights of the artifacts, components, or nodes determined during distance calculation, closely coupled components may be grouped together to form clusters as shown in the clustered component graph 900. To illustrate, the clustered component graph 900 depicts five mapped components 910-918 and one component cluster, a first cluster 902. In the example of FIG. 9, the clustered component graph 900 include a first component 910, a second component 912, a third component 914, a fourth component 916, and a fifth component 918. Although one cluster is illustrated in the example of FIG. 9 for simplicity, a clustered component graph may have multiple clusters.

As illustrated in FIG. 9, the first component 910 and the second component 912 are relatively close to one another, based on the distances of other components. The first and second components 910, 912 may be identified as being in a first cluster 902. Being including in the first cluster, may generate additional relationships for the components, such as generate new edges between the nodes associated with the components or indicate that that nodes associated with the components are candidates for merging.

As illustrated in FIG. 9, the third component 914, the fourth component 916, and the fifth component 918 are far from each other and far from a nearest cluster, such as the first cluster 902. Such components may not be put assigned to or put in a cluster, and the relationships of the components (and associated nodes of the knowledge graph) may not be altered (e.g., altered directly, such may be modified indirectly based on the other clusters). In some implementations, a threshold or thresholds are used to determine the clusters, such as density and/or distance thresholds. The thresholds may be static or dynamic. For example, a static threshold may require X number of components within Y distance, while a dynamic threshold may require different distances or densities based on a number of components and/or one or more other variables.

In a particular implementation, DBSCAN clustering is used. For example, the device may perform component clustering using a DBSCAN method or algorithm. To illustrate, based on the weights of the application artifacts (e.g., identified components), the artifacts are clustered into similar buckets using DBSCAN clustering. DBSCAN clustering, and other density and distance based clustering may help identify close related relations and group them together. Such density and distance based clustering schemes may provide advantageous clustering results over other more manual processes or processes which only account for distance (and which do not account for density), such as K-means.

Referring to FIG. 10, a diagram of examples of a component graph and a ranked component graph according to one or more aspects of the present disclosure are shown in diagram 1000. Diagram 1000 includes a component graph 1002 and a clustered ranked component graph 1004. The component graph 1002 may include or correspond to a component graph generated based on a knowledge graph or a knowledge model, and the clustered ranked component graph 1004 may include or correspond to an updated component graph generated based on the component graph 1002 and based further on the clusters identified in a clustered component graph, such as the clustered component graph 900 of FIG. 9. For example, the clustered ranked component graph 1004 may be modified (e.g., additional relationships or component merges) from the component graph 1002 based on similar nodes of clusters identified in the clustered component graph 900, similar relationships identified in the clustered component graph 900, or a combination thereof.

A component graph, such as the component graph 1002, may provide a syntactic or semantic representation of components or artifacts of a real world counterpart represented by a digital twin. For example, the component graph 1002 includes components A1, A2, A3, A4, A5, and A6. The component graph 1002 includes two component groupings, a first grouping 1012 of components (e.g., A1-A3) and a second grouping of components 1014 (e.g., A4-A7). Each of the components may have relationships or connections with another components. These relationships or connections are illustrated by lines, similar to the edges in FIGS. 2A-4. In the example of FIG. 6, the component A1 is related to A2 and the component A2 is related to component A3. Additionally, component A4 and component A5 are related to component A6 (i.e., directly), but only indirectly to each other, and component A6 is related to component A7. None of components A1-A3 are related to any of components A4-A7.

A modified component graph, the clustered ranked component graph 1004, may be generated based on the component graph 1002 and relationships 1022 (e.g., new relationships or connections between the components). The relationships 1022 may be generated based on the knowledge schema. As described with reference to FIGS. 5 and 9, clusters of components may be determined based on the artifacts/components being plugged into the knowledge graph. Additionally or alternatively, the relationships 1022 may be generated based on the clustered component graph 900 of FIG. 9, as described above.

In the example of FIG. 6, the relationships 1022 include determinations that Al and A4 are similar and that A2 and A6 are similar. Based on these determinations, a new component graph may be generated, such as the clustered ranked component graph 1004. The clustered ranked component graph 1004 includes the same components A1-A7 of the component graph 1002, however, in the clustered ranked component graph 1004 some of the components A1-A7 are combined into a single/shared component (or element), which may generate or identify additional relationships. For example, in the clustered ranked component graph 1004 A1-A3 are now related to components A4-A7. Specifically, A1 is now directly or indirectly related to each of A4-A7 in that A1 is directly related to A6 and indirectly related to A5 and A7. Additional direct relationships include A2 being related to A5 and A7 and A2 being related to A6.

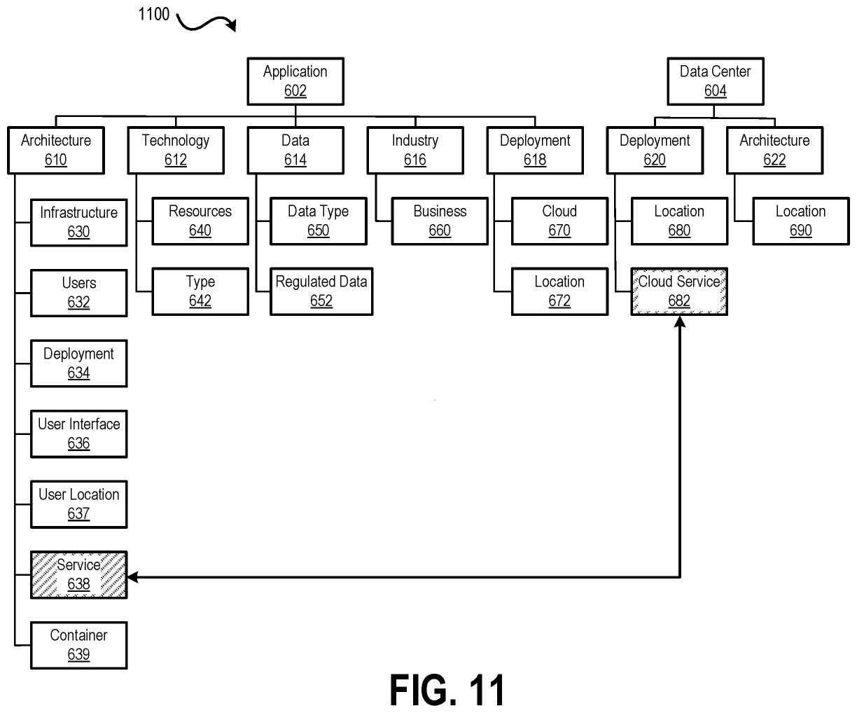

These additional relationships and the information therein can be used to update or modify digital twins, as described with reference to FIGS. 1 and 5, and further described with reference to FIGS. 11 and 12. For example, the knowledge schema (e.g., hierarchy information 111 or knowledge hierarchy model 600) may be updated, as further described with reference to FIG. 11, and the updated schema can be used to generate modified digital twins (modified to account for the information gained from the clustered ranked component graph 1004) during digital twin creation. As another example, the knowledge graphs (e.g., one or more knowledge graphs of knowledge graphs 112, knowledge graph 300, and/or knowledge graph 400) may be updated or a new knowledge graph (e.g., new heterogenous knowledge graph of knowledge graphs 112) may be generated during digital twin updating or merging, as further described with reference to FIG. 12. In some such implementations, knowledge graphs are also updated after updating the knowledge model schema. Similarly, the knowledge schema may be updated after the knowledge graph or graphs are updated or generated based on the updated knowledge graph.

Referring to FIG. 11, an example of an updated knowledge hierarchy model according to one or more aspects of the present disclosure is shown as knowledge hierarchy model 1100 (also referred to as an updated hierarchy model). The knowledge hierarchy model 1100 may include or correspond to an updated knowledge hierarchy model of the knowledge hierarchy model 600 of FIG. 6 and be indicated by or generated from hierarchy information 111 of FIG. 1. For example, an updated knowledge hierarchy may include an additional component, removal off a component, or modifying of a component. Modifying a component may include moving the component around (e.g. up or down a level) such that the component has different (e.g., additional or fewer) relationships.

As illustrated in the example of FIG. 11, the knowledge hierarchy model 1100, as compared to the knowledge hierarchy model 600 of FIG. 6, includes a new relationship between the service 638 and the cloud service 682 (as illustrated by the arrow). Additionally, or alternatively, the knowledge hierarchy model 1100 may include a modification to merge the service 638 and the cloud service 682, as illustrated by the cross hatching in FIG. 11.

An updated knowledge hierarchy model or updated knowledge hierarchy model information may be used to generate or update digital twins. For example, the updated knowledge hierarchy model 1100, when used, such as queried, may enable updating or generating knowledge graphs. To illustrate, a query, such as query 114 of FIG. 1, may return results indicating similar nodes and/or additional dependencies or relationships which can be used to generate or update knowledge graphs. As another example, the updated knowledge hierarchy model may be used to update multiple knowledge graphs or generate multiple knowledge graphs based on the updated architectures or schemas, such as the updated components and hierarchies or relationships between the components. To illustrate, knowledge graphs can be generated based on the updated knowledge hierarchy model during digital twin creation to generate improved and more accurate twins which account for other separate digital twins. As another illustration, existing knowledge graphs can be updated based on the updated knowledge hierarchy model after creation to be improved and more accurate representations of the digital twins which account for developments in the generation of other separate digital twins. Exemplary updates (including merging two knowledge graphs to form a new knowledge graph) to knowledge graphs are further described with reference to FIG. 12.

Referring to FIG. 12, an example of an updated knowledge graph according to one or more aspects of the present disclosure is shown as knowledge graph 1200 (also referred to as updated knowledge graph 1200). The knowledge graph 1200 may include or correspond to an updated knowledge graph (e.g., updated or heterogenous digital twin) based on the knowledge graph 300 of FIG. 3 and/or the knowledge graph 400 of FIG. 4. For example, an updated knowledge graph may include an additional node, removal of a node, or modification of a node. Modifying a node may include moving the node around such that the node has different (e.g., modified, additional, or fewer) relationships (e.g., edges) with other nodes.

As illustrated in the example of FIG. 12, the updated knowledge graph 1200 may include a modification (from the knowledge graphs of FIGS. 3 and 4) to merge the service node 320 of knowledge graph 300 of FIG. 3 and the cloud service node 410 of the knowledge graph 400 of FIG. 4. Merging of the service node 320 and the cloud service node 410 generates a new node, node 1210, a merged service node. Consequently, merging of the nodes to generate a new node generates a new or updated knowledge graph, which represents generation of a new or updated digital twin. Merging the nodes may alternatively referred to as merging the digital twins or conjoining the digital twins such that the updated knowledge graph 1200 now represents a larger heterogenous system comprised of smaller digital twins.

The merging of the previous nodes and generation of node 1210 may generate additional relationships or edges. For example, in FIG. 12, the knowledge graph 1200 includes an edge 1212 pointing from the application node 310 to the merged services node 1210, which indicates a relationship (e.g., a semantic relationship or other relationship) between the nodes 310, 1210, namely, that the ontology class application represented by the application node 310 is hosted by the merged services node 1210, as indicated by the label “hostedOn”, and therefore merged service is a subclass of the application. It is noted that the edges of the knowledge graph 400 may be defined such that they point from one node to another node (e.g., from node 310 to node 1210) or from a node to data, and the particular node an edge points to may be determined based on the semantic relationship information included in the ontology (e.g., the ontology 160 of FIG. 1).

Alternatively, in other implementations the updated knowledge graph 1200 may not include the node 1210, and instead the updated knowledge graph 1200 includes a new relationship (e.g., a new edge) between the service node 320 of knowledge graph 300 of FIG. 3 and the cloud service node 410 of the knowledge graph 400 of FIG. 4, similar to edge 1212. In such implementations, generation of the new edge (e.g., edge 1212) between the service node 320 and the cloud service node 410 may generate additional new relationships (indirect connections) between the nodes connected to the service node 320 and the nodes connected to the cloud service node 410. Similarity, the digital twins represented by the original knowledge graphs 300 and 400 may be said to be merged or conjoined like in the example where the nodes where merged. That is, the updated knowledge graph 1200 with the new edge also represents a larger heterogenous system comprised of smaller digital twins. The updated knowledge graph 1200, when used, such as queried, may enable outputs (e.g., insights) into modeling the entire system, that is the digital twin of the application represented by knowledge graph 300 and the digital twin of the network represented by knowledge graph 400. To illustrate, a query, such as query 114 of FIG. 1, may return results indicating operating metrics, virtual machines, auto scaler conditions, load balancing algorithms, etc. when the application is deployed on or hosted by the cloud service.

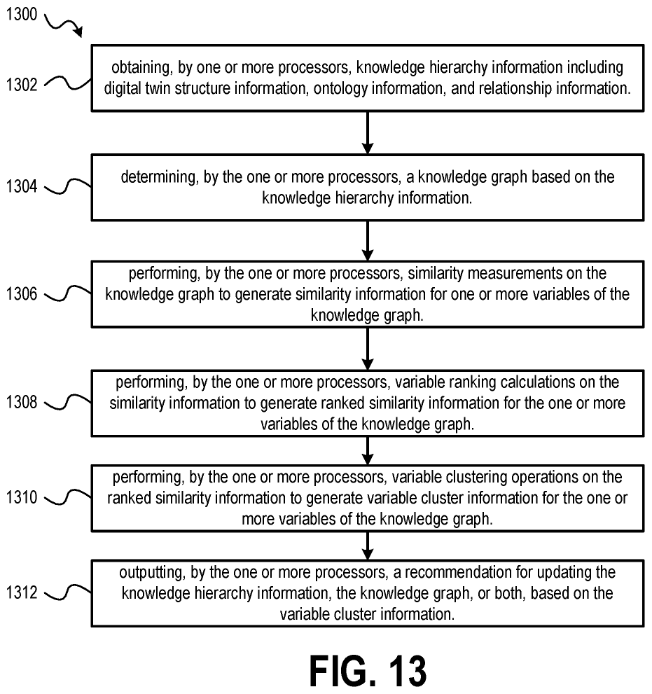

Referring to FIG. 13, a flow diagram of an example of a method for updating digital twins according to one or more aspects is shown as a method 1300. In some implementations, the operations of the method 1300 may be stored as instructions that, when executed by one or more processors (e.g., the one or more processors of a computing device or a server), cause the one or more processors to perform the operations of the method 1300. In some implementations, these instructions may be stored on a non-transitory computer-readable storage medium. In some implementations, the method 1300 may be performed by a computing device, such as the computing device 102 of FIG. 1 (e.g., a device configured for creating and/or updating digital twins).

The method 1300 includes obtaining, by one or more processors, knowledge hierarchy information including digital twin structure information, ontology information, and relationship information, at 1302. For example, the knowledge hierarchy information may include or correspond to the hierarchy information 111 of FIG. 1, the knowledge model 504 of FIG. 5, or the knowledge hierarchy model 600 of FIG. 6 and the ontology may include or correspond to the ontology 160 of FIG. 1 or the ontology 592. The digital twin structure information and the relationship information (e.g., interconnections) may include or correspond to the schema 590 or the information of the knowledge hierarchy model 600 of FIG. 6. To illustrate, the one or more processors of the computing device 102 of FIG. 1 may receive the knowledge hierarchy information from another device, retrieve it from a local database, or generate the knowledge hierarchy information based on the domain data 162 and ontology 160 or based on the schema 590 and the ontology 592.

The method 1300 includes determining, by the one or more processors, a knowledge graph based on the knowledge hierarchy information, at 1304. The knowledge graph represents a digital twin of a real world counterpart. For example, the knowledge graph may include or correspond to a knowledge graph of the knowledge graphs 112 of FIG. 1, the knowledge graph 300 of FIG. 3, or the knowledge graph 400 of FIG. 4. In some implementations, the knowledge graph represents a digital twin of the systems 154 of FIG. 1.

The method 1300 includes performing, by the one or more processors, similarity measurements on the knowledge graph to generate similarity information for one or more variables of the knowledge graph, at 1306. For example, the similarity information may include or correspond to the data points of FIG. 7 or information, such as distance information, derived from the data points, such as the Gowers' distance values of FIG. 8. The one or more variables may include or correspond to components of the on-premise systems 154 or on-premise agents 594, or to the nodes of a knowledge graph, such as service 320 or cloud service 410. To illustrate, the one or more processors of the computing device 102 of FIG. 1 may encode nodes of the knowledge graph to generate data points which represent a similarity between each of the nodes or can be used to determine a similarity between each of the nodes.

The method 1300 includes performing, by the one or more processors, variable ranking calculations on the similarity information to generate ranked similarity information for the one or more variables of the knowledge graph, at 1308. For example, the ranked similarity information includes the ranked similarity information of FIGS. 8 and 9. To illustrate, the one or more processors of the computing device 102 of FIG. 1 may perform distance calculations, such as Gowers' distance calculations, on the data points to determine a distance between each of the data points. The distances between the data points may represent the similarity between the data points. The data points may be graphed before distances are calculated in some implementations.

The method 1300 includes performing, by the one or more processors, variable clustering operations on the ranked similarity information to generate variable cluster information for the one or more variables of the knowledge graph, at 1310. For example, the variable cluster information includes the cluster information for the nodes as illustrated in FIGS. 9 and 10. To illustrate, the one or more processors of the computing device 102 of FIG. 1 may perform density and distance based clustering, such as density-based spatial clustering of applications with noise (DBSCAN) operations, to cluster representations of the nodes of the knowledge graph, such as the data points, into clusters.

The method 1300 includes outputting, by the one or more processors, a recommendation for updating the knowledge hierarchy information, the knowledge graph, or both, based on the variable cluster information, at 1312. For example, the recommendation may include or correspond to the recommendation 164 of FIG. 1 or to the recommendation 532 of FIG. 5. To illustrate, the one or more processors of the computing device 102 of FIG. 1 may generate and output the recommendation 164/532 indicating an update or change to the knowledge graph or the knowledge hierarchy, such as illustrated in FIGS. 11 and 12. The recommendation may be sent to another device, as illustrated in FIG. 1, displayed on a GUI of the computing device 102 for manual confirmation or implementation, or sent to another component of the computing device 102 for implementation (automatic implementation).

As described above, the method 1300 for updating or generating digital twins in an ontology-driven manner with less user input and that support improved querying capabilities as compared to other digital twins or individual information graph and probabilistic graph model-based technologies. For example, the method 1300 enables a user to provide an ontology from which a first layer (e.g., a domain ontology knowledge graph) of a multi-layer probabilistic knowledge graph is generated. The method 1300 also enables automatic generation, based on the domain ontology knowledge graph, of a second layer (e.g., a probabilistic ontology graph model) of the multi-layer probabilistic knowledge graph by mapping ontology domains to random variables and sampling domain data. This technique allows for quick conversion of domain knowledge into conditional probability distributions, which can be processed faster than the domain data itself. By storing the distributions as a layer on top of and integrated with the domain ontology knowledge graph, both layers can be accessed (e.g., traversed) simultaneously, enabling more flexible types of queries with better performance as compared to individually querying single models and aggregating the results.

It is noted that other types of devices and functionality may be provided according to aspects of the present disclosure and discussion of specific devices and functionality herein have been provided for purposes of illustration, rather than by way of limitation. It is noted that the operations of the method 1300 of FIG. 13 may be performed in any order. It is also noted that the method 1300 of FIG. 13 may also include other functionality or operations consistent with the description of the operations of the system 100 of FIG. 1 and the process of FIG. 5.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-7) include processors, electronics devices, hardware devices, electronics components, logical circuits, memories, software codes, firmware codes, among other examples, or any combination thereof. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits, and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules, and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may also be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media can include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, hard disk, solid state disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified—and includes what is specified; e.g., substantially 90 degrees includes 90 degrees and substantially parallel includes parallel—as understood by a person of ordinary skill in the art. In any disclosed aspect, the term “substantially” may be substituted with “within [a percentage] of” what is specified, where the percentage includes 0.1, 1, 5, and 10 percent; and the term “approximately” may be substituted with “within 10 percent of” what is specified. The phrase “and/or” means and or.

Although the aspects of the present disclosure and their advantages have been described in detail, it should be understood that various changes, substitutions and alterations can be made herein without departing from the spirit of the disclosure as defined by the appended claims. Moreover, the scope of the present application is not intended to be limited to the particular implementations of the process, machine, manufacture, composition of matter, means, methods and processes described in the specification. As one of ordinary skill in the art will readily appreciate from the present disclosure, processes, machines, manufacture, compositions of matter, means, methods, or operations, presently existing or later to be developed that perform substantially the same function or achieve substantially the same result as the corresponding aspects described herein may be utilized according to the present disclosure. Accordingly, the appended claims are intended to include within their scope such processes, machines, manufacture, compositions of matter, means, methods, or operations.

What is claimed is:

1. A method for updating digital twins, the method comprising:
obtaining, by one or more processors, knowledge hierarchy information including digital twin structure information, ontology information, and relationship information;
determining, by the one or more processors, a knowledge graph based on the knowledge hierarchy information, wherein the knowledge graph represents a digital twin of a real world counterpart;
performing, by the one or more processors, similarity measurements on the knowledge graph to generate similarity information for one or more variables of the knowledge graph;
performing, by the one or more processors, variable ranking calculations on the similarity information to generate ranked similarity information for the one or more variables of the knowledge graph;
performing, by the one or more processors, variable clustering operations on the ranked similarity information to generate variable cluster information for the one or more variables of the knowledge graph; and
outputting, by the one or more processors, a recommendation for updating the knowledge hierarchy information, the knowledge graph, or both, based on the variable cluster information.

2. The method of claim 1, further comprising:
updating, by the one or more processors, the knowledge hierarchy information, the knowledge graph, or both based on the recommendation to generate updated knowledge information; and
running, by the one or more processors, a query against the updated knowledge information to obtain a query result, wherein the query corresponds to a software development query and the query result indicates an outcome or optimization of one or more variables of knowledge graph.

3. The method of claim 2, wherein updating the knowledge hierarchy information, the knowledge graph, or both further includes:
merging the knowledge graph with at least one other knowledge graph to generate an updated knowledge graph, the updated knowledge graph representing a heterogenous digital twin system;
generating the updated knowledge graph and modifying a knowledge model hierarchy indicated by the knowledge hierarchy information based on the updated knowledge graph;
modifying a component or relationship of the knowledge model hierarchy; or
modifying the knowledge model hierarchy and updating one or more knowledge models representing multiple digital twins based on the modified knowledge model hierarchy.

4. The method of claim 1, wherein obtaining the knowledge hierarchy information includes:
generating, by the one or more processors, the knowledge hierarchy information based on the ontology information and domain data corresponding to a domain associated with the ontology information; or
receiving, by the one or more processors, the knowledge hierarchy information from a knowledge hierarchy instantiator or database.

5. The method of claim 1, wherein determining the knowledge graph includes:
generating, by the one or more processors, the knowledge graph based on ontology data and domain data corresponding to a domain associated with the ontology information; or
receiving, by the one or more processors, the knowledge graph from a knowledge graph instantiator or database.

6. The method of claim 5, wherein generating the knowledge graph includes:
analyzing, by the one or more processors, data source information, and optionally the knowledge hierarchy information, to generate analyzed data source information;
analyzing, by the one or more processors, twin architecture artifact information to generate twin architecture information;
extracting, by the one or more processors, components from the data source information and the twin architecture information as candidate nodes for the knowledge graph; and
querying, by the one or more processors, the knowledge hierarchy information to determine relationships among the components and label them to generate nodes for the knowledge graph.

7. The method of claim 1, wherein performing the similarity measurements further includes:
converting, using one-hot encoding, knowledge graph variables into data points based on the knowledge graph and using the knowledge hierarchy information; and
performing similarity measurements on the data points.

8. The method of claim 7, wherein performing similarity measurements on the data points includes:
calculating Gowers' distance between each data point; and
calculate weights for each data point based on the corresponding Gowers' distance for each data point to understand a similarity between the data points.

9. The method of claim 8, wherein performing variable ranking calculations further includes:
performing, based on the weights of the data points, density and distance based clustering of the variables associated with the data points to generate a cluster graph.

10. The method of claim 9, wherein performing variable clustering operations further includes:
grouping closely coupled variables of the cluster graph together to form clusters based on one or more grouping thresholds; and
identifying one or more similar variables of a particular cluster of the clusters, one or more relationships of the one or more variables of a cluster, or both, wherein the recommendation is generated based on the identified one or more similar variables, the identified one or more similar variables, or a combination thereof.

11. A system for creating digital twins, the system comprising:
a memory; and
one or more processors communicatively coupled to the memory, the one or more processors configured to:
obtain knowledge hierarchy information including digital twin structure information, ontology information, and relationship information;
determine a knowledge graph based on the knowledge hierarchy information, wherein the knowledge graph represents a digital twin of a real world counterpart;
perform similarity measurements on the knowledge graph to generate similarity information for one or more variables of the knowledge graph;
perform variable ranking calculations on the similarity information to generate ranked similarity information for the one or more variables of the knowledge graph;
perform variable clustering operations on the ranked similarity information to generate variable cluster information for the one or more variables of the knowledge graph; and
output a recommendation for updating the knowledge hierarchy information, the knowledge graph, or both, based on the variable cluster information.

12. The system of claim 11, wherein the one or more processors are further configured to:
provide an application programming interface (API) that provides recommendation or query building functionality;
receive a user input indicating one or more query parameters; and
generate the recommendation or a query based on the user input.

13. The system of claim 11, wherein the one or more processors are further configured to:
display a graphical user interface that includes the recommendation or a query result.

14. The system of claim 11, wherein the one or more processors are further configured to:
generate a control signal based on the recommendation or a query result; and
transmit the control signal to the real world counterpart.

15. The system of claim 11, wherein the real world counterpart is a machine, a workflow, a process, an entity or enterprise, or a combination thereof

16. A non-transitory computer-readable storage medium storing instructions that, when executed by one or more processors, cause the one or more processors to perform operations for updating digital twins, the operations comprising:
obtaining knowledge hierarchy information including digital twin structure information, ontology information, and relationship information;
determining a knowledge graph based on the knowledge hierarchy information, wherein the knowledge graph represents a digital twin of a real world counterpart;
performing similarity measurements on the knowledge graph to generate similarity information for one or more variables of the knowledge graph;
performing variable ranking calculations on the similarity information to generate ranked similarity information for the one or more variables of the knowledge graph;
performing variable clustering operations on the ranked similarity information to generate variable cluster information for the one or more variables of the knowledge graph; and
outputting a recommendation for updating the knowledge hierarchy information, the knowledge graph, or both, based on the variable cluster information.

17. The non-transitory computer-readable storage medium of claim 16, wherein the knowledge graph comprises a plurality of nodes and edges connecting at least some of the plurality of nodes to one or more other nodes.

18. The non-transitory computer-readable storage medium of claim 17, wherein:
each of the variables corresponds a node of the plurality of nodes; and
directed edges between nodes represent conditional dependencies between variables corresponding to the nodes.

19. The non-transitory computer-readable storage medium of claim 18, wherein the variables are mapped to domain ontology classes of the ontology information and relationships between classes of the ontology information are mapped to dependencies between the variables.

20. The non-transitory computer-readable storage medium of claim 19, wherein each of the edges corresponds to a use relation between two nodes of the plurality of nodes, wherein the knowledge graph represents syntactic relationships, semantic relationships, or both, and wherein the knowledge hierarchy information includes or corresponds to a knowledge hierarchy model.
